(19) United States
(12) Patent Application Publication
(10) Pub. No.: US 2009/0037311 A1
(43) Pub. Date: Feb. 5, 2009

(54) SYSTEM FOR AND A METHOD OF A MULTIFUNCTION TRANSACTION

(75) Inventor: Ralph Mahmoud Omar, London (GB)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: Ralph Mahmoud Omar, London (GB)

(21) Appl. No.: 12/184,686

(22) Filed: Aug. 1, 2008

Related U.S. Application Data
(60) Provisional application No. 60/953,768, filed on Aug. 3, 2007.

(51) Int. Cl. G06Q 40/00

(52) U.S. Cl. 705/35

(57) ABSTRACT

A system for processing a multifunctional ticket is described. The ticket represents an entry item in both a short-term multiple-entry event and a long-term event. The system comprises: receiving means for receiving a request for a user entry into the short-term multiple-entry event; authorising means for implementing an authorisation event authorising the request, the authorising means being arranged to generate a unique ticket identifier associated with the user entry; first storing means for storing the unique ticket identifier and a timestamp relating to the request authorisation event in a database record relating to a first function of the ticket; identification obtaining means for obtaining owner identifier information relating to an owner of the multifunction ticket independently of the authorisation event; and second storing means for storing the owner identifier information, the unique ticket identifier or an identifier uniquely associated with the ticket identifier and the timestamp or a date associated with the timestamp in a database record relating to a second function of the ticket, wherein the first and second functions are executed on different timescales and the first function relates to the short-term event and the second function relates to the long-term event.

### CROSS-REFERENCE TO RELATED APPLICATIONS

This application claims the benefit of U.S. Provisional Application Ser. No. 60/953,768, filed Aug. 3, 2007.

### FIELD OF THE INVENTION

The present invention relates to a system for and a method of handling a multifunction transaction. More specifically, though not exclusively, the present invention relates to a method of and a system for handling a new multifunction transaction, which supports a new financial instrument that is more attractive than previous financial instruments, but which at the same time complies with strict Islamic law (and/or other sets of laws or regulations which impose strict limitations on the functional operation of those instruments such as those related to risk, speculation, gambling and games of chance and investment) on validly derivable benefits from such transactions. The present invention is directed to both the technical system and method of handling such new multifunction transactions as well as the new financial instrument itself.

### BACKGROUND OF THE INVENTION

The present invention arises out of a long felt need to provide attraction to long-term financial investment products within the constraints of an acceptable instrument under a country's constrained financial laws, such as Sharia'h law (Islamic Law). Creating an instrument which can accord with these laws places technical constraints on any system handling such new financial instruments. Overcoming these technical constraints represents a technical problem to which one aspect of the present invention is directed. Therefore, in order to understand these constraints to which the present technical invention needs to comply, some explanation of the prohibitions in complex Sharia'h law needs to be understood. This is set out below as background information to understanding the present invention.

The Principles and Main Products of Islamic Finance.

Interest vs. Usury. The basic principle of Islamic banking is the prohibition of Riba, which can paradoxically be translated as usury or interest. This creates some disagreement amongst Islamic scholars.

The literal meaning of interest or Al-RIBA as it is used in the Arabic language means to exceed or increase. In mainstream Islamic terminology, interest is synonymous with usury and means effortless profit or that profit which comes free from compensation or that extra earning obtained that is free of exchange of efforts or risk. One scholar Hazrat Shah Waliullah Dehlvi says, “Riba' is a loan with the condition that the borrower will return to the lender more than and better than the quantity borrowed.”

Islamic principles of finance are based on a well-established rule, which dictates that: “The benefit of a thing is a return for the liability for loss from that thing”. So a sharing of risk is accepted and the avoidance of unequal transactions offering riskless or unearned rewards unaccepted.

Islamic finance eschews any interest based transactions, yet at times in the recent past zero coupon bonds and other interest based constructions more usually found in the arsenal of Western financial institutions have been used, but are now falling into disuse.

There is a considerable degree of debate over the difference in the meaning between interest and usury.

Interest by contrast to Riba or “usury” is an English word and herein lies the misunderstanding under which some scholars define Riba as interest and others as Usury, allowing for different forms of financial approach.

Scholars like Mohammad Fadel hold conflicting views in which Riba is of two types, riba duyun (riba of debts) and riba buyu (riba of sales). The former is what the Quran refers to as a war against God and His Prophet. The latter is something specifically prohibited by the Prophet in his sunna. Those transactions described as involving riba by the sunna were not understood to involve riba by the Arabs at the time of the revelation.

Riba duyun, occurs when a creditor agrees to allow his debtor to delay payment of a matured debt in exchange for an increase in the indebtedness. For example, A owes B $100 on 1/1. On 1/1 B is unable to pay A so A agrees not to collect his debt until 2/1 in exchange for B agreeing to pay him $110 instead of $100. This is an increase on a pre-existing indebtedness, and for that reason is called riba dayn or riba duyun (the increase of a debt). This transaction is categorically prohibited. It is called riba al-jahiliyya, or the usury of the time preceding Islam, jahiliyya not having its full potential meaning, that of ‘ignorance’. It is specifically this transaction that the Arabs understood riba to include.

The riba of the sunna applies to certain types of sales transactions, both immediate exchanges as well as credit exchanges. It is commodity specific. The riba that is specific to immediate exchanges is called riba al-fadl. The basic rule is that immediate exchange is not subject to the rules of riba unless there is some dalil or evidence that the commodity in question is subject to the specific rules of riba al-fadl. As long as the commodities are generically different, the rules of riba al-fadl are never an obstacle to immediate exchanges. Thus, while 1 pound of high-quality dates for 2 pounds of lower quality dates is prohibited on the grounds of riba al-fadl, 1 pound of high quality dates for 2 pounds of wheat is not riba al-fadl, even if the wheat is then traded for 2 pounds of the lower quality dates.

The riba that applies to credit sales is called riba nasi'a. Nasi'a means delay. Again the same structure applies. Credit sales are not subject to the rules of riba nasi'a unless there is evidence that the commodity that is traded has been marked out for special regulation. The cause of prohibition in this type of riba, is merely delay in exchange (nasi'a), and not the difference in cash price and credit price. Again, to give an example, the sale of a car whose cash price is $10,000 for $12,000 on credit, payable over 5 years, for example, is not prohibited under the rules of riba nasi'a: according to the fuqaha' the commodity simply has two different prices, a cash price and a credit price. Nor does this transaction implicate riba duyun because the purchaser is incurring a debt, not increasing the value of a pre-existing indebtedness in exchange for more time to pay off the debt. Therefore, it also does not involve riba al-jahiliyya.

According to economists, the difference in price is a function of the time value of money, i.e., interest. Therefore, the terms riba and interest are not synonymous, and Fadel thus believes that Muslims should cease confusing one for the other. Some riba is interest, but not all, e.g., trading one pound of high quality dates for two pounds of lesser quality dates does not implicate the time value of money at all, yet Islam describes it as riba. Likewise, some interest is riba, but not all: if I owe the bank $100 and agree to defer payment of the debt in exchange for increasing my indebtedness, that is both interest and riba. However, if I buy a car on credit, I will be paying interest, but not riba.

The Main Principles of Islamic Banking

Any predetermined payment over and above the actual amount of principal is prohibited.

Islam allows only one kind of loan and that is qard-el-hassan (literally good loan) whereby the lender does not charge any interest or additional amount over the money lent. Traditional Muslim jurists have construed this principle so strictly that, according to one commentator “this prohibition applies to any advantage or benefits that the lender might secure out of the qard (loan), such as riding the borrower's mule, eating at his table, or even taking advantage of the shade of his wall.” The principle derived from the quotation emphasises that associated or indirect benefits are prohibited.
b) The lender must share in the profits or losses arising out of the enterprise for which the money was lent.

Islam encourages Muslims to invest their money and to become partners in order to share profits and risks in the business instead of becoming creditors. As defined in the Sharia'h, Islamic finance is based on the belief that the provider of capital and the user of capital should equally share the risks and successes of business ventures, whether those are industries, farms, service companies or simple trade deals. Translated into banking terms, the depositor, the bank and the borrower should all share the risks and the rewards of financing business ventures. This is unlike the interest-based commercial banking system, where all the pressure is on the borrower: he must pay back his loan, with the agreed interest, regardless of the success or failure of his venture.

Islam encourages investments in order that the community may benefit. However, it is not willing to allow a loophole to exist for those who do not wish to invest and take risks, but to hoard money or deposit money in a bank in return for receiving an increase on these funds for no risk (other than the bank becoming insolvent). Accordingly, under Islam, either people invest with risk, or suffer loss through devaluation by inflation by keeping their money idle. Islam encourages the notion of higher risks and higher returns and promotes it by leaving no other avenue available to investors. The objective is that high risk investments provide a stimulus to the economy and encourage entrepreneurs to maximise their efforts.
c) Making Money from Money is not Islamically Acceptable.

Money is only a medium of exchange, a way of defining the value of a thing; it has no value in itself, and therefore should not be allowed to give rise to more money, via fixed interest payments, simply by being put in a bank or lent to someone else. The human effort, initiative, and risk involved in a productive venture are more important than the money used to finance it. Muslim jurists consider money as potential capital rather than capital, meaning that money becomes capital only when it is invested in business. Accordingly, money advanced to a business as a loan is regarded as a debt of the business and not capital and, as such, it is not entitled to any return (i.e. interest).

Muslims are encouraged to purchase and are discouraged from keeping money idle so that, for instance, hoarding money is regarded as being unacceptable. In Islam, money represents purchasing power, which is considered to be the only proper use of money. This purchasing power (money) cannot be used to make more purchasing power (money) without undergoing the intermediate step of it being used for the purchase of goods and services.
d) Gharar (Uncertainty) is also Prohibited.

Under this prohibition any transaction entered into should be free from uncertainty, which by some is sometimes expanded in meaning to include risk and speculation. Contracting parties should have perfect knowledge of the counter values intended to be exchanged as a result of their transactions. Also, parties cannot predetermine a guaranteed profit. This is based on the principle of ‘uncertain gains’, which on a strict interpretation, does not even allow an undertaking from the customer to repay the borrowed principal plus an amount to take into account inflation. The rationale behind the prohibition is the wish to protect the weak from exploitation. Therefore, options and futures are considered as un-Islamic and so are forward foreign exchange transactions because rates are determined by interest differentials.

A number of Islamic scholars disapprove the indexation of indebtedness to inflation and explain this prohibition within the framework of qard-el-hassan. According to those scholars, the creditor advances the loan to win the blessings of Allah and expects to obtain the reward from Allah alone.

A number of transactions are treated as exceptions to the principle of gharar: sales with advanced payment (bai' bithaman ajil); contract to manufacture (Istisna); and hire contract (Ijara). However, there are legal requirements for the conclusion of these contracts to be organised in a way which minimises risk.

e) Investments should only support practices or products that are not forbidden by Islam.

Trade in alcohol, for example would not be financed by an Islamic bank; a real-estate loan could not be made for the construction of a casino; and the bank could not lend money to other banks at interest.

Permissible Instruments & Schemes.

There are thus a resulting number of transactions that eschew interest and avoid other prohibitions and are thus considered Halal or permissible under Islamic law and which are potentially to be used as the basis of creating Islamic instruments. These are:

Murabaha

Mudaraba

Musharaka

Muqarada

Ijarah

Salam

Istisna

Bay Bithamin Ajil (BBA)

The Definition of Gambling and the Difference Between Gambling and Speculation

Put simply, as done by the early jurists or fuquaha, in Islam gambling is a game in which one party wins while the other loses. Moreover every transaction in which gain and loss is obscure is known as Qimaar' and ‘Maysir’ in the Sharia'h terminology.

Several scholars have addressed the issue of whether speculation in the stock market, which perforce involves a level of skill, is similar to gambling, from different angles. Kamali (1996) defines speculation as consisting of “the intelligent and rational forecasting of future price trends on the basis of evidence and knowledge of past and present conditions”. Based on the Quranic verses and the Hadith of the Prophet, Ibn Taymiyah pointed out that if a sale contains Gharar and devours the property of others, it is the same as gambling, which is clearly forbidden. Therefore, for a transaction to be equated to gambling, it must involve the devouring and unlawful appropriation of the property of others. Against this backdrop, speculative risk taking in commerce, which involves the investment of assets, skills and labour, therefore is not similar to gambling. This is because the buyer is engaged in a transaction aimed at making profit through trading and not through simple appropriation of the property of others.

Whilst for some Muslims speculation in the stock markets may look like gambling, yet it is by no means akin to gambling. Speculation has both pros and cons from the Islamic point of view. Its positive side is that it can help stabilize prices and activate a market where there is thin trading. It can also provide signals to less-informed investors upon which to act. The negative effect of speculation is that excessive amounts of it may cause volatile price movements in the market. Most Muslims therefore conclude that excessive speculation should not be allowed, but a reasonable degree of it be permitted. Quantitative limits on daily trading volume and legislative guidelines may help contain speculation within healthy bounds, however no workable definition of what separates excessive from reasonable speculation has been developed.

Furthermore, any kind of financial transaction with financial uncertainty and risk attached to the transaction itself is also forbidden and hence the religion of Islam forbids this jointly together with all types of gambling including lotteries, wagering, and casinos.

It should be emphasized that Islam does not prohibit a contract just because it involves risk. Only when risk is a channel to make one party profits at the expense of the other that it becomes Gharar, which is forbidden.

A crucial aspect of the zero-sum measure is that it is based on gains and losses of each player. The question thus arises as to how one can decide on the criterion by which one is considered losing or gaining? For example, it might be argued that seller of a lost camel does not lose anything. Since the camel is already lost, he does not lose by selling it. In fact, his level of wealth is higher than without sale even if the camel is found. So how can he be a loser?

The answer is that he loses a potential gain that he was entitled to had he not sold the camel. To clarify this point, suppose the camel is worth 1000 dollars, and that the camel is found by pure chance. Suppose that the seller believes the chance of finding the camel is 20%. Then he will not accept a price less than 0.2(1000)=200. If the chance is 40%, then he will ask for 400 instead. Why? Because this is what the seller is giving up. The buyer benefits from the contract that which the seller gives up as a forgone profit. Had the owner not sold the camel, he could have found it himself and enjoyed its full market price. So if the camel is found, the seller loses the difference between its market value, which he was entitled to, and the price he received, i.e. 200−1000=−800, which is exactly the same amount that the buyer wins. If the camel is not found, the seller wins the price, 200, that the buyer loses. So it is a zero-sum game where one party wins only at the expense of the other. However, a theoretic gain alone would not be covered, i.e. if the camel was not yet owned or at least had been in the possession of the seller, then the western economist concept of opportunity cost would not suffice.

In many respects, stock markets are viewed by some as gambling casinos. Many practices in these markets are considered Gharar, and therefore bear a strong resemblance to gambling. A legitimate question, however, arises concerning the difference between buying a lottery ticket and buying a share in the stock market. A clear difference is that a lottery is a zero-sum game: The winner of a lottery wins only at the expense of the others. In a stock market, all participants might win when economic conditions are favourable. Collective winning in a lottery is impossible, but feasible in a stock market. Thus the former is a zero-sum game but the latter is not meaning that the zero-sum measure is clearly based on economic understanding of exchange. Here one finds a criterion stated by Sharia'h rules and maxims. Not surprisingly, but contrary to a common belief, there exists a well-defined and clear measure of Gharar in Sharia'h: It is the established Hadith “liability justifies utility or return”

Liability Justifies Return

Generally speaking, almost all unlawful transactions violate this maxim, including Gharar. The term “liability” in the Hadith by its nature involves risk. It means assuming the risk of loss or damage of the asset such that it is no more beneficial or utilizable. The “liability justifies utility” maxim establishes the principle of “justice” in Islamic economics. Rights and obligations must be balanced—though not exactly or equally, and this balance is essential for proper economic incentives. Thus whilst it can be easily seen that eating other's money for nothing necessarily implies imbalance between rights and obligations for each party, the problem is in measuring unequal returns and risks. That is, the zero-sum structure is unjust, as Ibn Taymiah points out.

The Premium Bond Market & LLDAs. Governments in countries where gambling is forbidden or restricted have also attempted secondary initiatives by bringing in gambling like instruments underneath ordinary financial market regimes.

Thus partly in response to initiatives at the start of the 90s in a variety of Muslim countries by the present inventor and partly in response to the results of the UK Premium bond scheme, Governments and banks around the world have introduced savings instruments that combine savings with a lottery including traditional premium Bonds and lottery linked bank accounts. Lottery-linked bank accounts are thus not a new idea. They represent a subset of the range of actual and hypothetical securities with randomized payoffs.

The basic structure of a Lottery Linked Deposit Account (LLDA) is simple. Typically, the bank automatically enrols in a lottery those depositors who maintain a deposit of some specified size for some specified period in the designated accounts. Commonly, the depositor receives one lottery ticket or chance, each month for every X dollars he has on deposit for that month. The buyer pays for her lottery tickets by foregoing interest relative to an account that does not have the lottery feature. The lottery does not affect the principal of the bond or deposit, but the interest rate that the holder receives each period is a random variable. The interest rate the holder actually receives could be very low (perhaps zero or only nominal, depending on the scheme's structure) or it could be very high, if the owner is lucky enough to win the grand prize.

The issuer's incentive to offer the accounts or bonds is that savers like the lottery feature and reward the issuers by accepting a lower return on the accounts than they would receive on an account that provided a certain return. The account holders may be accepting a bet that is unfair to them, or not.

The lottery feature may simply be a marketing device that differentiates the account from other types of savings instruments. Equally, the accounts may lower the offering bank's cost of funds. When the lottery is not a—fair game“i.e., when the expected value of a ticket is less than the foregone interest, the bank gains.

For the bank offering the LLDA, the monetary cost is deterministic, not random, and consists of three components: administrative costs, an explicit interest cost, and then lottery payout. Both regular deposit accounts and LLDAs require administration and it appears that the administrative costs are higher for LLDAs than for regular accounts. The LLDAs are interest bearing, but at a rate that is one-half or two-thirds that of regular savings deposits. As for the lottery component, the bank announces, in advance, a payout that is independent of the amount in qualifying accounts. Unlike the situation with many state lotto games, all prizes are awarded and there is no rollover. Over time the banks can adjust the number and value of the prizes to the number of qualifying accounts to maintain a target expected value and competition between banks should lead to at least periodic adjustment. Periodically banks would have to change the prizes to maintain customers' interest.

Offering LLDAs is subject to both production and consumption economies of scale. The bank has to invest in the computer program to assign the chances to accounts, and to pick the winning account. It also has to advertise the accounts. These investments are a fixed cost that does not increase with the number of accounts the bank holds. There may also be another benefit to scale. Small banks cannot match the large banks in terms of the frequency and the richness of the prizes and as this matters to the demand for a lottery this has resulted in several small U.S. states banding together to offer joint lotteries. Although a small bank with its less frequent prizes may match a larger bank in terms of the expected value of its accounts, it may suffer from a marketing disadvantage people often predict by representativeness and over-estimate the probability of rare, salient events. A bank that advertises winners more frequently than its competitors may benefit from such effects. Lastly, the larger bank can more readily increase the skewness of its payouts.

Banks offering LLDAs have to know how to market the accounts. This involves not just advertising, but also the management of the prizes in terms of their structure and composition so that periodically their banks would have to change the prizes to maintain customer's interest.

In considering a solution to the above-described problem, the issue of how to implement the innovative solution also needs to be considered. This may also result in further challenges that need to be overcome.

It is desired to overcome the problems outlined above. More specifically, it is desired to provide a system for and a method of handling and processing a new multifunctional transaction which complies with Sharia'h Law (and/or other sets of laws or regulations which impose strict limitations on the functional operation of those instruments such as risk, speculation, gambling and games of chance and investment) and one which reduces the administration burden.

### SUMMARY OF INVENTION

According to one aspect of the present invention there is provided a system for processing a multifunctional ticket, the ticket representing an entry item in both a short-term multiple-entry event and a long-term event, the system comprising: receiving means for receiving a request for a user entry into the short-term multiple-entry event; authorising means for implementing an authorisation event authorising the request, the authorising means being arranged to generate a unique ticket identifier associated with the user entry; first storing means for storing the unique ticket identifier, and a timestamp relating to the request authorisation event in a database record relating to a first function of the ticket; identification obtaining means for obtaining owner identifier information relating to an owner of the multifunction ticket independently of the authorisation event; and second storing means for storing the owner identifier information, the unique ticket identifier or an identifier uniquely associated with the ticket identifier and the timestamp or a date associated with the timestamp in a database record relating to a second function of the ticket, wherein the first and second functions are executed on different timescales and the first function relates to the short-term event and the second function relates to the long-term event.

It is to be appreciated that the term ‘long-term’ is intended to have a specific meaning of a time period over at least six years, preferably over ten years and possibly over twenty years. Also, the term ‘medium-term’ is intended to mean a year to four years and the term ‘short-term’ is intended to have a specific meaning of less than a year, preferably one or two months.

The system of the present invention is arranged to handle a new type of financial investment instrument that is compliant with Sharia'h law for example (and/or other sets of laws or regulations which impose strict limitations on the functional operation of those instruments), which is hereinafter referred to as a new prize incentive bond. The characteristics of the new instrument create difficulties in system implementation that are addressed by one aspect of the present invention. The new prize incentive bond of another aspect of the present invention is based on an appreciation that the financial conditions defined by Sharia'h law can be accommodated in an enhanced long-term investment vehicle which has a short-term marketing aspect associated with it. Typically, that short-term marketing concept is an automatically selected or self-selected number-based prize scheme such as a selectable numbers lottery, which can help to market the long-term financial investment vehicle attached to it. This has the advantage of enhancing the attractiveness of the long-term financial investment to the user.

The main concept underlying the acceptability in Sharia'h Law of the new prize incentive bond is that the consideration paid for the prize incentive is fully refunded by the long-term investment whilst at the same time being able to be used for a short-term prize event. This is not considered to be gambling as is prohibited by Sharia'h Law because the consideration (i.e. purchase money etc.) can be fully recovered at the end of the long-term. In other words, an ordinarily impermissible gambling transaction is altered by use of another already legally defined permissible transaction so as to redefine it legally as acceptable. The point is that consideration in terms of (i.e. purchase funds) in the classic definition of gambling as prize, consideration and chance, is removed. As there is technically no consideration for the prize aspect of the prize incentive bond, so too technically the purchaser cannot be a loser. And as there is no longer a loser, then this is no longer a zero-sum game with uncertainty or Gharar as it is known in Islamic law. Accordingly, this new prize incentive bond, which is handled and processed by the system of present invention, is permissible.

The combining of a short-term and a long-term event, which underpins the new type of financial instrument, in itself creates a technical difficulty in implementation. This is because the considerations and requirements for a short-term function are in many respects very different to those of a long-term event and lead to incompatibility issues. For example, for the short-term event it is important that the user can validate their tickets quickly and at many different types of purchase outlet. The very nature of such transactions requires the ticket to be cheap and have a relatively short operational life. Also the ticket itself in these short-term events typically acts as the only user record of the transaction and gives its owner its short-term value if any.

Conversely, a long-term event is by its very nature a more substantial issue and the ticket needs to be able to provide a means of being able to participate in the long-term event in a reliable manner. It also typically involves a different providing entity to that of the short-term event and usually requires registration, as otherwise it would become similar in nature to a bearer bond. With registration comes the issue of proof of identity that slows down interaction with the terminal.

These incompatibility issues are discussed in greater detail later and are addressed by the technical solution provided by the present invention.

The present invention, in one aspect, can be considered to be a multifunction lottery ticket, in which a unique entry into short-term lottery event is provided together with a means for registering into a long-term investment event, wherein a unique ticket number assigned to the ticket for the short-term lottery event is related to a unique reference number provided on a carrier which can be provided for entry into the long-term investment event upon registration of the unique ticket number, the unique ticket number and the unique reference number being related to each other in a verifiable way which requires machine-stored information not present on the carrier.

The prize incentive bond, of the present invention, achieves permissibility by effectively creating a multifunction (long-term event and short-term event) capability. More specifically, a portion of the consideration provided by the customer to buy his ticket is placed into one form of economic transaction, usually the purchase of a capital/financial market instrument of some nature (whether equity or future or option or debt or other financial transaction is unimportant for the principle to work), and another portion is used for a short-term prize based event in which the customer has active participation by determining a user-selected option. Accordingly, the nature of the whole transaction is changed to be legally compliant. This is thus termed the ‘abstraction method’ of implementing the ‘Acceptability Principle’ (the Acceptability Principle being partly derived from the idea that by divorcing the opportunity from winning a prize from paying for that opportunity such that where the opportunity to win a prize is removed from the payment for that opportunity except by the means of foregoing another opportunity to earn interest, the prize earning opportunity is no longer considered gaming). By making the prize-earning opportunity instrument acceptable, it enables the long-term financial investment to become more attractive without contravening Islamic law.

Another broad way of considering the present invention is that it is a mechanism for exempting the process of competing in a lottery, for example, from the strict Muslim definition of gambling by use of the above described abstraction method, namely using a portion of the wager in the lottery for investment in a long-term bond which will repay the full cost of the wager at some point in the future.

Preferably, the short-term event is a lottery event and the multifunction ticket is a modified lottery product, which can be referred to as a lottery bond or a lottery premium bond, a premium bond style lottery product or a modified premium bond style product (see below). However, it is very different to known premium bonds as is described below. As mentioned above, the new type of transaction instrument referred to above is very different from a conventional premium bond in several ways. Firstly, a normal premium bond repays or has the ability to repay its principal or face value at par within a relatively short period of its purchase by the customer—usually within a short to medium term, i.e. from a few months (short) to one to four years (medium). Secondly, the prize of a premium bond is thus on the whole quite a bit smaller than that usually associated with a short-term prize draw for example as the prize is normally drawn from a short-term interest rate pool as premium bonds tend not to pay dividends or interest until the expiry of up to one to two years. Thirdly, premium bonds are usually not anonymous and have to be registered in some way to the purchaser. Otherwise, if they were bearer redeemable, the transaction costs of producing them and selling them would become very high, as the bond itself would have to include security devices equal to or greater than cash as they would be tempting for a forger. Fourthly, premium bonds have no long-term event (such as a redemption event) associated with them, they are redeemable at any time after an initial period after purchase. Further, premium bonds often require a minimum number to be purchased, for example one hundred £1 premium bonds, so as to cover the cost of the sale through a secure outlet which is relatively high. Lastly, premium bonds often entitle the holder to enter multiple draws further reducing the prize pool.

It is important to understand the attributes and variations of the new inventive prize incentive bond (lottery bond). These attributes and variations also enable better understanding of the problems, which present invention's method and system for handling and processing the bond, addresses. Accordingly, set out below are some further details regarding the new transactional instrument.

The prize incentive bond has a relatively low value, but is used to purchase a financial instrument/guaranteed investment of some description, on the purchaser's behalf, paying a predictable sum at a certain long-term date—(akin to a Zero Coupon Bond etc although not equivalent where a pure Islamic interest eschewing structure is required). The term ‘low value’ is intended to imply a value less than $10 and preferably $1 akin to the cost of a typical lottery ticket. As mentioned previously, the bond also has an element which is used for a short-term prize draw (typically a lottery) which is otherwise normal, except for the fact that only a part of the purchaser's (player's) relatively low-value original stake is used for the prize draw, namely it acts as an incentive to purchase the long-term bond.

This use of part of the purchaser's stake to purchase a financial instrument of some description on his behalf in this fashion is in order to insure the real potential full return of his original stake at some point in the future. Such real potential stake return transforms the prize incentive (lottery) ticket from being considered potentially as a gambling instrument into a financial instrument of some sort e.g. a debt and/or equity instrument. The actual future date of return (and thus the type of investment picked) is long-term (as described before) but can be determined by different factors which can depend on the legal regime governing capital markets, the preferences of the local state sponsoring organisations, the preferences of the local purchasers and what delay before the return of his original stake the player is willing to tolerate.

There are multiple alternatives to this approach, which return the full amount of the original stake at only one specific (long-term) time in the future. These alternatives can be tailored according to local requirements; e.g. part or all of the amount that would have been placed in a zero-coupon type of investment maturing at some single point in the future, may be turned into a multiple coupon investment paying interest dividends at intervals thus eventually adding up to the total stake amount originally ventured by the purchasers Alternatively, the investment may be placed in an equity and/or future fund i.e. offsetting the player's opportunity of being given a definite date when his money is guaranteed to be returned, in return for his having the non-guaranteed chance of an even earlier redemption (possibly with profits). Also conceptually by delaying the guaranteed date of payback, therefore releasing more of the original amount from placement in instruments (with a guaranteed return) to placement in non-guaranteed investments, the purchasers could be offered a low-rate of return on top of the guarantee of his stake back. Again it is stressed that in all of the above cases a minimum term of 6 years would apply to the earliest possible redemption. In this way the long-term event and the short-term event characterisation of the present invention is maintained.

It is also possible to create a purely Islamic bond, which uses the new so-called Islamic bond constructions that are being advanced by Islamic banks as the underlying investment vehicle for the transaction. Whilst these Islamic bonds may appear rather complicated in concept and construction to the issuer, their advantage is that they appear very simple and straightforward to the purchaser.

This Islamic bond product would replace the zero coupon/financial instrument element of the above-described prize incentive bond with a pure Islamic finance method element. The share of what would have been the prize incentive bond's ticket sale proceeds (that would have been placed into a zero coupon bond issued by a local bank) can now be placed into a profit-based Islamic equity or other form of investment managed on behalf of the ticket purchaser by an Islamic bank or by the Islamic banking arm of a local bank.

Some of these Islamic investment concepts as applied to the prize draw incentive contract are worth explaining in more detail here as although the construction is complicated in theory, in reality all that is happening is that the portion of the money that would have been placed in the zero coupon bond is being placed in another financial instrument, i.e. the Islamic bond. The only material change the customer will see will be the phraseology and the form of a short sentences on the ticket as explained below.

The winning of prizes is Halal (permissible therefore blessed, but only if they do not involve real as opposed to theoretical or opportunity loss i.e. loss through the expenditure of money with the primary purpose of wining the prizes without the existence of real trading of goods or skills). In the case of the zero coupon scheme, Sharia'h law prohibitions are avoided by ensuring that the return of the money at some point in the future which means that no real loss through expenditure of money Is actually taking place—just a theoretic opportunity cost through a no interest loan with charitable purpose which is allowable under Islam. Since the prize was not the benefit of the loan itself, it could be termed Qard Hassan (mentioned earlier).

However with an Islamic financial product that carries a prize as an incentive to buy, a profit may be forecasted, but this is a profit, which cannot be specified or promised otherwise it becomes forbidden as it is regarded as interest. Furthermore, a profit cannot be guaranteed, it must be combined with a real prospect of loss, otherwise it again becomes interest earning and this is forbidden as usury. Thus whilst putting 10% for example of the purchase price of a ticket into an Islamic style zero coupon bond is possible, —i.e. the bank acts as a trustee for the money to invest it in projects which pay back in the form of rent over a given period in order to effectively ensure the return the principal and whilst the rent can be outlined implicitly at the start thus enabling the bank to specify the date of return of the principal purchase price (the zero coupon element that defeats anti-gaming laws), the profit element i.e. the rental returns over and above the return of principal can be designated as profit and remain unspecified.

The key here is that the bank can enter into an Islamic contract with the ticket purchaser to use his money to build real projects which are technically owned by the ticket purchaser and which the banks then leases from the purchaser (the rental contract that enables the bank, as an ordinary rental contractual counterparty, to guarantee a zero coupon rent—i.e. a rent that piles up and is repaid at one go in order to issue a guarantee of the return of the original purchase money at some point in the future. The Islamic bank will also declare itself a partner with the purchaser in the sub lease of those properties leased by the bank to the real user of the properties for a rental over and above the rent the bank pays to return the capital—the profit element. The difference between the total rental the bank pays and the total rental paid by the sub lessee will be the difference between the banks cost of funds and the mortgage rate available to individuals in the market as this will work out as a mortgage as the sub lessee will acquire the property in the end of the loan. This way of contracting can be extended to numerous types of transactions and have included for example even the financing of multi-million forestry operations in Malaysia.

In reality neither the purchaser, nor the operator will see these legal constructions. The operator will receive his money, then under the abstraction method turn over an agreed percentage for example up to 25% of the purchase price on his behalf to the Islamic Bank, to be completely invested by them on his behalf. The Islamic Bank's name will be on the prize incentive bond ticket as the issuer who promises to pay the bearer his money back with profits (“for exact date of repayment see bank”). Nevertheless, the repayment would still be classified as a long-term event.

Arguably what really happens with all Islamic finance is that ordinary loan contracts are rewritten in a way that reflects the above theoretic money ownership flow which is permissible under Islamic law but, in fact, attempt to match as closely as possible ordinary banking transactions in control, real responsibility and interest rate.

In this scheme, the overall proforma contract between the bank and the theoretic player will be validated by the Sharia'h committee of the bank and the prize incentive bond ticket will for example read on the back “Your money is returnable in full with profits for exact date see notice displayed in The bank of . . . validated by the Sharia'h committee of the bank of . . . and approved by Sheikh X”

Having devised a new type of investment property as one aspect of the present invention, the prize incentive (lottery) bond, the manner in which the bond is generated, distributed and used has also been addressed by the inventor. There are technical issues which need to be addressed which result from the incompatibility of user participation in linked long and short-term events.

Any system handling long-term bonds or entries into long-term events, has certain requirements which need to be fulfilled.

Typically, entries into medium to long-term events, to which a user has access, require the user to have a long-term ticket, which has certain characteristics specific to the nature of use of the ticket.

The long-term ticket needs to be obtained from a secure point-of-sale such that the issuer can have confidence that the entries into the long-term event will be sold under secure conditions. If this were not the case then there would be an unacceptable increase in fraud opportunities, for example, the seller could say he has lost certain long-term event tickets and thereafter use them for himself. Typically, the secure-point-of-sale is at a bank, a post-office or via secure financial institution.

The long-term event ticket is usually issued upon registration of the user into a central register of the issuer relating to the long-term event. The registration is by the secure retailer acting as an agent and involves an identification process at the point-of-sale. Here, the long-term event ticket is assigned to the name of a person (normally that has been validated either using a common identity item validation process i.e. passport, or a previous account opening process and specific identity validation i.e. bank account number/address details/credit card number) and recorded in a general register of the issuer. Often the register will be linked to a file containing a signature requiring a fallible human signature validation process. This process is time-consuming and requires the secure retailer to have the ability to authenticate identification documents, such as passports etc. Similarly, on completion of the long-term event, the owner of the long-term event ticket will typically be required to prove their identify to obtain any benefits which have accrued to them by completion of the long-term event.

The long-term event ticket usually requires security features to be built into it to prevent fraud. Security features in the actual ticket itself are typically required to enable a validation at various points in the life cycle of the ticket to whether the long-term event ticket is real or a forgery. Some long-term event tickets can be akin to a bearer type bond, namely the owner of the ticket can claim its value in the future, without the need for any identification. In this case, the paper ticket has a value itself, similar to a banknote, and so needs security features to prevent fraudulent copying. In these cases very stringent fraud prevention measures are employed, such as those on a banknote (watermarking, foil strip in paper, etc). Also the paper on which the ticket is printed needs to be robust enough to survive until the future event occurs. These security measures are expensive and long lasting according to the degree and value and expected life of the ticket.

However, these features are at odds with typical requirements and characteristics of a short-term event ticket that are described below.

Typically, short-term event tickets are mass-produced and need to be relatively cheap. The ticket substrate only needs to last short period of time for claiming prize relating to short-term event for example. Whilst the ticket itself needs to have some form of security, the degree of security is far less than that of a long-term event ticket. Ticket distribution and generation needs to be of a low cost to enable low-value tickets to be sold. In this regard, the tickets are often machine-generated. Also to enable widespread distribution, the short-term event tickets need to be sold via non-secure retail outlets. The ticket issuance needs to be fast in order to function in a general-purpose retailer environment. Also the ticket needs, if possible, to be able to have an anonymous ticket purchase capability. Typically the ticket itself, in these short-term events, acts as the only user record of the transaction and gives its owner its short-term value if any.

Further, the systems managing short-term events need to be able to delete or overwrite records which identify information relating to the short-term event such as the unique ticket number, the selected lottery numbers, the time and date of authentication of the ticket, the retailer outlet from where the ticket was purchased together with other numerous fields of information relating to the short-term event, in order to be able to cope with the vast numbers of entries in each short-term event, typically in the tens of millions for each say weekly lottery event. This deletion is normally carried out after the period for claiming the prizes, for example six months, has expired. If this were not done the storage space required to store full records for each entry into each short-term event over a long-term time period would increase exponentially and would quickly become unworkable. This is completely at odds with long-term event requirements where all records need to be maintained until the long-term event has occurred and for a period of time after that event.

These factors have lead to an industry-wide acceptance that tickets for short-term and long-term events are mutually exclusive as they have such differing technical requirements. This presents a technical prejudice that the inventor has overcome.

The present invention addresses this prejudice, an thereby provides a technical solution which can be used to implement the new type of prize incentive bond. It does this by providing a multifunction ticket and system for operating with the multifunction ticket, which together operate in facilitating both the long-term event and the short-term event but crucially separate the authorisation of the entry into the short-term event from the registration of the entry into the long-term event.

The term ‘registration’ is intended to mean the process of user registration with a system or database, which involves the user inputting their personal details and the creation of a personal record of the personal details. Whilst typically this is the first time a user uses a new system, it is not intended to cover situations where the system creates a record pertaining to that user's interaction with the system, which does not involve the user entering all of their personal details.

The separation of the user registration for the long-term event from the short-term event authorisation enables the prejudice that the two different functions are incompatible to be overcome. The simple authorisation of the short-term event entry can be carried out quickly and, if required, anonymously at a non-secure retail outlet, such as a supermarket or convenience store. The retailer is not entrusted with any bonds of any value and the process can be automated though use of remote terminals for connection to the system.

In particular, the incompatibility is addressed by having a multifunction ticket which fulfills all of the short-term requirements by being low cost, not requiring a lengthy operation to activate the ticket, not requiring a proof of identity to take part in the short-term event and being constructed to have a relatively short operational life. The long-term requirements are addressed by the unique ticket number, which is assigned to the multifunction ticket in the short-term event, providing the link between the short-term event and the long-term event. In one embodiment the unique ticket number is made available by the system involved in the short-term event and preferably within the short-term life of the multifunction ticket, for example six months, it can be used to register its holder, with proof of identity, into the long-term event. It can alternatively be pre-registered before participation in the short-term event, without effecting the short-term event participation requirements. Once registered, the multifunction ticket can be replaced by a unique reference number provided on a carrier, for example on a more durable certificate, a proprietary swipe card or a mobile phone (later embodiment). This unique reference number is related to the unique ticket number in a verifiable way that requires machine-stored information that is not present on the carrier.

In one embodiment, the multifunction ticket can be printed on simple degradable thermal paper (for low cost) without any paper security features. The only security feature would be the system-generated authentication number (ticket ID number) printed on the ticket itself. In this embodiment the ticket only acts as a facilitator for later registration of the ticket with the long-term event. In another embodiment, where the purchaser uses a pre-registered ticket on a proprietary swipe card, only the security required to use the pre-registered ticket needs to be employed, for example a PIN, which is far less onerous than security in the authenticity of the ticket substrate itself, for example. In either embodiment, the security is shifted away from the retailer to the authentication means of the system and the need for a point-of-sale registration process is obviated. Also, advantageously, the present invention facilitates impulse purchasing and also the purchase of multifunction tickets with cash.

The multifunction ticket if the present embodiments can be obtained at non-secure retail outlets, without requiring any purchaser registration at the point of sale and using an automated terminal. This keeps the cost of the ticket relatively low and keeps the purchase procedure relatively quick for the purchaser.

The storage incompatibility problem is solved by providing two different data storage means related to a single-purchase transaction. The first stores all of the information required for the short-term event (lottery draw) for example the ticket number, the outlet where the ticket was purchased, the time and date of purchase, the user selected numbers of the ticket, any security codes etc, in a data record. The second data store holds a smaller subset of this, for example, only the unique ticket number and the date stamp together with user-registration data. Here, the user registration data may simply be provided in a single data file (user's name and address) which is referenced by multiple long-term event entries. This takes a significantly smaller amount of space than individual records with all of the required details for both long-term and short-term events. Alternatively, as shown in other embodiments described later, the lottery ticket may relate to a pre-registered user in which case the registration data may be held separately from the actual long-term event data and simply be referred to by use of a registration number in the long-term event data store. This latter embodiment can also be adapted to represent a very secure way of using personal data in relation to both the long-term and short-term events.

The post registration embodiment has many benefits associated with it. For example anonymity of the user in purchasing the ticket, the ability for the user to use cash in purchasing of multifunction tickets, and purchasing from a wide distribution network. The purchaser can also purchase on his own behalf or in another's behalf or even accommodate a change of mind where the purchaser later assigns the multifunction ticket to another person. This may possible by after the short-term event has occurred, e.g. I buy for me to win this week's prize but leave the bond redemption to my relatives. Prior to the present invention buying a premium bond for example for another, (i.e. a child or someone else) meant applying by post or at a secure location able to handle the transaction using a secure registration process.

Therefore, whilst a conventional premium bond is normally a registered bond, using the system of the present invention, it is possible to render the multifunction ticket capable of being bearer bond (whilst remaining fully secure for purchaser and issuer) for part of its lifecycle which can then become registered and even change ownership legally and securely prior to or after registration.

The conventional purchase of a premium bond, for example by phone and or the internet, requires personal confidential information to be given. In the system of present invention, secure bearer-only registration is achieved on a widely distributed terminal network, or phone or Internet purchase without the transmission of private information that the purchaser may be unwilling to provide. In other words, the system of the present invention need only be tied to an algorithm of the authenticating means and hence a number known only to the purchaser, not his personal information.

Furthermore, the conventional premium bond purchaser doesn't have immediate security of purchase on a phone or Internet purchase, i.e. the details will be subject to a time-delayed purchaser-provided details validation process. This means that the prior art online site/telephone centre will have to take time to compare all details such as address, birth date, credit card number against available records (this is often done after the sale). If the purchaser's credit card number and address provided to the prior art online premium bond site doesn't match his credit card address previously provided to his credit card supplier, the sale will be voided, even though the error could be innocent or as harmless as a wrong spacing in the zip code held on record by the credit card supplier with the zip code provided to the website.

Another advantageous feature of the present invention relates to its responsiveness. The system of the present invention handles management of the long-term event in real-time. This means that the system knows all of the multifunction tickets, which have been purchased, the ones that have won the prize, those that have been redeemed, those that have expired and the revenue generated from those ticket sales. This real-time information can be very useful in managing the system and is particularly helpful when the prize is of a variable amount needing to be of a magnitude proportional to the volume of sales of multifunction tickets, for example, which has never previously been possible.

Due to security and registration issues, conventional premium bonds normally have a fixed prize. The total sales to a given moment of a normal premium bond due to its security features are not accounted for on a live basis showing the issuer in real-time how many premium bonds have been sold and therefore technically issued. Prizes, therefore, are usually a fixed defined amount rather than a percentage of the prize pool designated on a real-time basis. The present invention advantageously is implemented on a system, which does provide real-time accounting. Each sale and lottery ticket can be tracked and accounted for. This means that the lottery bonds of the present invention can take advantage of a marketing phenomenon caused by the prize pool growing with purchases (in real time) during the sales period, which causes, in turn, an increase in the propensity to buy lottery bonds incremental with the increase in the prize pool.

Correspondingly, this lack of real-time accounting for the total sales and therefore the total available prize pool, also does not allow for what is known as a ‘rollover’ prize whereby a previous sales period's prize is added to a new sales period's prize. This is because management of a lottery rollover prize requires a tight accounting process that can only occur within the shorter sales and prize draw periods that can take place once a computer-based real-time book entry system allows for a dramatic shortening of the accounting cycle. Rollover prizes also require a correlation between the serial numbers on the premium bonds issued to be made with the serial number of the prize draw, such that if there is a discrepancy a rollover has occurred. This means that with a conventional premium bond in the period between the end of the prize draw date and the commencement of a new set of sales, there isn't sufficient time to examine the records of all bonds sold up to the prize draw period and calculate whether or not the prize draw number corresponds with the serial number of a bond sold.

A real-time fully accounted system of the present invention advantageously allows for this calculation on an immediate basis between the end of one prize draw period and the commencement of a new prize draw/sales period. The determination that there is a possibility of no winning number for a particular lottery draw would allow for a rollover. This doubling of potential prize can mean a huge increase in sales propensity in the new sales period where there is a rollover.

An important technical element of the present invention resides in the fact that the promotional domain of prize draws and the domain of financial instruments are traversed by purchase of a user ticket which is referenced by a unique identifier which is common to both domains. This unique identifier accommodates the different requirements of both domains whilst at the same time maintaining the integrity of both domains. The present system records the unique identifier or information derivable from it in two different data stores (first and second) and separates out the procedure for registration in the long-term event from the short-term event purchase procedure. The advantages of the present invention are achieved by separating the different uses of this information in this way whilst at the same time retaining a link between both uses.

Advantageously, the receiving means is arranged to receive a unique card registration identifier with the authorisation request and the authorisation means is arranged to access a pre-registered user database to determine whether the card registration number is valid for authorisation. The use of pre-registration of the user means that the ticket can be a proprietary multi-function card which allows the user to only interact with the system once to be included in both the long-term and the short-term events.

The identification obtaining means is preferably a database of pre-registered users and the system may further comprise means for querying the database to obtain details of the pre-registered user.

Alternatively, the identification obtaining means is a database of pre-registered users and the system may further comprise means for querying the database to obtain a unique pre-registered reference identifier to the pre-registered user. In this way, secure databases can be accessed to obtain a unique user reference without giving away the users identity. This is a very secure way of entering into both a short-term and the long-term events without holding the identification details of the user on a non-secure database for many years (long-term event).

In this case, the second storing means can be arranged to store the unique pre-registered reference identifier as the identifier uniquely associated with the ticket identifier.

Preferably the request includes at least one user-selected option and the first storing means stores the at least one user-selected option in the database record relating to the first function of the ticket. This makes the user interaction with the prize more stimulating and makes the new instrument more attractive.

The system preferably further comprises processing means for using an algorithm to convert the unique pre-registered reference identifier into the identifier uniquely associated with the ticket identifier. This enables two different unique numbers to be used for two different events with both numbers being linked by the system.

The request may be received from a remote ticketing terminal and the system may further comprise transmission means for transmitting a unique identification number back to the remote ticketing terminal, the unique identification number being linked to the timestamp and the at least one user-selected option. This allows for a distributed system to be advantageously used such that multiple remote terminals can be providing the services to users whilst a single central server for example can be providing the backbone of the system itself. This is the most efficient way of configuring such a system.

This arrangement addresses the need when the system needs to be able to accommodate both anonymous and registered users for the short-term multi-user event and the strict requirements of identity in the long-term event where tickets could be lost and a bearer bond type system is not acceptable, namely the holder of the ticket is the owner of the entry into the long-term event. This issue is solved by operation of one embodiment of the present invention in two distinct stages a short-term event stage and then a registration stage for the long-term event with no requirement in the short-term stage of the identity of the user to be provided to the system.

The system may further comprise a remote ticketing terminal for issuing the multifunction ticket and the remote ticketing terminal may comprise local authentication means arranged to carry out a local authentication procedure of the card owner. In this way a secure check of ownership can be carried out, for example such a CHIP and PIN check.

The remote ticketing terminal may be arranged to have access to the first storing means and is arranged on presentation of the unique ticket identifier, to determine whether the short-term event has occurred and whether the at least one-user-selected option associated with the unique ticket identifier, matches a stored short-term event result information item. This way of processing the results of the short-term event means that users can return to the terminal where their ticket was issued to claim a short-term prize for example.

The receiving means can be arranged to receive the unique identification number; and the system may further comprise: comparing means for comparing the received unique identification number with the unique ticket number stored in the first storing means; and long-term event handling means for generating a unique long-term event identification number uniquely related to the unique ticket number and for sending the same to the second storing means if the unique identification number and the unique ticket number match. This is an alternative to storing the ticket identifier in the second data store, which provided a greater degree of security as the operator of the second store does not have knowledge of the identifier used in the short-term event.

The comparing means is preferably arranged to compare the date of receipt of the unique identifier with the timestamp associated with the unique identifier and to enable generation of the unique long-term event identification number if the time between the current date and the timestamp is less than a predetermined value. In this way the separate registration of the user with the long-term event can be controlled to be within a specified time-scale. This enables the handling of the registration process to be determinate over a given timescale.

The system may further comprise a remote issuing terminal for issuing a user-identifying entry in the long-term event, the issuing terminal comprising: means for forwarding the unique identifier number to the receiving means; entering means for entering in user identification information; obtaining means for obtaining the identifier uniquely associated with the ticket identifier; and producing means for producing a user-identifiable certificate for an entry in the long-term event.

The remote issuing terminal may be arranged to have access to the second storing means and may be arranged on presentation of the identifier uniquely associated with the ticket identifier, and user identification information to determine whether the long-term even has occurred.

The remote ticketing terminal may comprise a surrendering module arranged to enable surrender of a multifunction ticket for which the short-term event has passed and the long-term event has still to occur, the surrender module may be arranged to enable the issue of a new multifunction ticket at a discount and to send instructions to the second storing means for the cancelling of the entry in the long-term event corresponding to the surrendered ticket.

The present invention also extends to a multifunction ticket or like information store for use with a system as described above.

According to another aspect of the present invention there is provided a multifunction ticket or like information store, representing an entry item in both a short-term multiple-entry event and a long-term event, the ticket comprising: a machine-readable unique ticket identifier, the identifier providing means for identifying pre-registered information about the owner of the ticket; and a timestamp or information relating thereto concerning the date of a ticket authorising procedure; wherein a specific one of the multiple possible functions of the ticket can be determined and authenticated by use of the machine-readable unique ticket identifier and the timestamp.

The multifunction ticket may further comprise a plurality of prepaid elements, each element representing an entry into the multiple entry short-term event and into the long-term event, the ticket being arranged to mark each prepaid element once it has been used to participate in the multiple-entry short-term event.

The ticket identifier, timestamp and user-selected options may be stored electronically in the ticket. This can for example be within a chip of an electronic multifunction card. Alternatively, the ticket may preferably comprise electronic data within a mobile telecommunications device.

The ticket identifier, timestamp and user-selected options may alternatively be stored graphically on the ticket, such as for example in a two-dimensional bar code.

Preferably the multifunction ticket may further comprise an image of a collectable character or an element of a game apparatus. This makes the ticket more attractive to collect and play with as well as use the ticket in the short-term and long-term events mentioned previously.

According to a further aspect of the present invention, there is provided a method of processing a multifunctional ticket, the ticket representing an entry item in both a short-term multiple-entry event and a long-term event, the method comprising: receiving a request for a user entry into the short-term multiple-entry event; implementing an authorisation event authorising the request, the implementing step including generating a unique ticket identifier associated with the user entry; storing the unique ticket identifier and a timestamp relating to the request authorisation event in a database record relating to a first function of the ticket; obtaining owner identifier information relating to an owner of the multifunction ticket independently of the authorisation event; and storing the owner identifier information, the unique ticket identifier or an identifier uniquely associated with the ticket identifier and the timestamp or a date associated with the timestamp, in a database record relating to a second function of the ticket, the method further comprising executing the first and second functions on different timescales with the first function relating to the short-term event and the second function relating to the long-term event.

It is also possible to create a purely Islamic bond, which uses the new so-called Islamic bond constructions that are being advanced by Islamic banks as the underlying investment vehicle for the transaction. Whilst these Islamic bonds may appear rather complicated in concept and construction to the issuer, their advantage is that they appear very simple and straightforward to the purchaser.

This product would replace the zero coupon/financial instrument element of the above described prize incentive bond with a pure Islamic finance method element. The share of what would have been the “prize incentive bond's ticket sale proceeds (that would have been placed into a zero-coupon bond issued by a local bank) can now be placed into a profit-based Islamic equity or other form investment managed on behalf of the ticket purchaser by an Islamic bank or by the Islamic banking arm of a local bank.

Another way of effecting the present invention, which takes advantage of the Acceptability Principle described previously, is termed the ‘Attachment Method’. Here in order to effect a change in the legal definition of transaction which comprises entry into a lottery, the amended transaction can use a portion of the wager purchase consideration for the purchase of an economic good or service as in the right to obtain some service or product or the actual purchase of a service or product, such as a chocolate bar. Here the acceptability principle is thus described as being applied through he use of the attachment device.

Thus the normal definition of gambling, which includes prize, chance and consideration is overturned by redirecting the consideration to another transaction which includes the right to enter a prize selection process of some sort based on chance.

The main advantage is that instead of abstracting a portion of the money used for the short-term gambling purchase to purchase another economic good leaving a mixed transaction which appears heavily weighted in price towards the short-term gambling transaction as the economic good is perforce of a lesser price than the gambling transaction (since it is purchased out of a portion of the gambling proceeds), the economic good under the attachment device method can be of an equal or greater price than the gambling transaction which can have great benefits in reinforcing the public image of the product as opposed to merely allowing it to be acceptable in law. There are also some goods, in particular retail based investment products, whose price is so high that they can sustain, without changing their price, which may engender anti-sweepstake legislation, the effective insertion of an attachment device.

The difference between this second method of effecting the Acceptability Principle and the already existing use of sales promotion schemes through the use of prizes and prize draws as promotional devices is that these sales promotion schemes are mainly directed at the encouragement of the purchase of the ordinary products (whose purchase renders the purchaser liable to win the prize) and thus that they firstly are a genuinely promotional activity as opposed to another way of effecting a gambling transaction. They are different secondly in that the prizes themselves are of a much smaller order since they are ordinarily purchased out of what would have been the ordinary marketing budget normally applied elsewhere than for the purchase of promotional prizes. In other words only real gambling transactions can produce real gambling size prizes. In contrast to the normally relatively small prizes of sales promotion schemes, the effecting of the Acceptability Principle through the use of an attachment device can produce the same prize as the $1 lottery i.e. millions of dollars, but could still benefit from both being legally termed and regarded by the public as a sales promotion device, especially since the actual economic transaction is effectively the sale of a new as yet unpriced (and so out of the range of anti-sweepstake legislation) financial product for $5 where the seller has decided to put the increased sales proceeds into a lottery product.

Therefore, using the attachment principle and according to another aspect of the present invention there is provided a method of exempting the process of competing in a short-term gaming event from a strict Muslim definition of gambling, the method comprising: purchasing a commercial good or service together with an entry into the short-term gaming event which is attached to the purchase of the commercial good or service; using a portion of the user-paid price for the good or service for entry into the short-term gaming event; authorising entry into the short-term gaming event at the same time as the purchase; and providing to the user a receipt regarding the user entry into the short-term gaming event, wherein entry into the short-term gaming event is considered permissible under the strict Muslim definition of gambling, as it is attached as an incentive to a purchase the good or service.

This is a relatively simple way of achieving the desired objective of making the gaming event participation compliant with strict Muslim laws as the potential gambling element is considered to be simply a purchasing incentive.

The present invention also extends similarly to a system for exempting a process of competing in a short-term gaming event from a strict Muslim definition of gambling, the system comprising: a remote terminal for providing an ability to purchase a commercial good or service together with an entry into the short-term gaming event which is attached to the purchase of the commercial good or service; a central server spaced apart from the remote terminal for using a portion of the user-paid price for the good or service for entry into the short-term gaming event; and authorising means provided at the server for authorising entry into the short-term gaming event at the same time as the purchase; wherein the terminal is arranged to provide to the user a receipt regarding the user entry into the short-term gaming event, wherein entry into the short-term gaming event is considered permissible under the strict Muslim definition of gambling, as it is attached as an incentive to a purchase the good or service.

Whilst the use of the attachment device method makes the product comply with Sharia'h law for example, an element of the main method of effecting the Acceptability Principle could be brought in to further make the product more acceptable to sceptical purchasers. This could be done by offering an equal prize to all purchasers of the economic goods, such as a chocolate bar. Here by abstracting a portion of the $1 gambling proceeds and placing it in a financial instrument, all purchasers could be offered a rebate or prize of $1 at some point in the future. The significance of this is that the definition that gambling depends upon prize, chance and consideration, has been avoided by the present product because consideration has been removed and everyone has been given an equal chance of a prize, thereby eliminating chance at one prize level.

Furthermore, a method whereby the winner of the big prize, i.e. $ millions as opposed to the $1 rebate, has the option to give it to the charity of his choice should he so wish could also be attached. The importance of this is that whilst the user has the option to keep the winnings, which may be frowned upon by a limited number of people, he also has the option to give it away to charity. Whilst ultimately this is down to the purchaser, the product would meet the stringent requirements of being acceptable and ‘clean’ as Islam regards charity as having to be an individual voluntary act.

Some of these Islamic investment concepts as applied to the prize draw incentive product are worth explaining in detail as although the construction is complicated in theory, in reality all that is happening is that the portion of the money that would have been placed in the zero-coupon bond is being placed in another financial instrument, i.e. the Islamic bond. The only change the customer sees is in the phraseology and the form of a short sentence on the ticket as explained below.

The winning of prizes is Halal (permissible), but only if they do not involve real as opposed to theoretical or opportunity loss, i.e. loss through the expenditure of money with the primary purpose of wining the prizes without the existence of real trading of goods or skills). In the case of the zero coupon scheme, Sharia'h law prohibitions are avoided by ensuring that the return of the money at some point in the future which means that no real loss through expenditure of money is actually taking place—just a theoretic opportunity cost through a no-interest loan with charitable purpose which is allowable under Islam. Since the prize was not the benefit of the loan itself, it could be termed Qard Hassan (mentioned earlier).

However, with an Islamic financial product that carries a prize as an incentive to buy, a profit may be forecasted, but this is a profit that cannot be specified or promised otherwise it becomes forbidden as it is regarded as interest. Furthermore, a profit cannot be guaranteed, it must be combined with a real prospect of loss, otherwise it again becomes interest earning and this is forbidden as usury. Thus whilst putting 10% for example of the purchase price of a ticket into an Islamic-style zero-coupon bond is possible, i.e. the bank acts as a trustee for the money to invest it in projects which pay back in the form of rent over a given period in order to effectively ensure the return the principal and whilst the rent can be outlined implicitly at the start thus enabling the bank to specify the date of return of the principal purchase price (the zero-coupon element that defeats anti-gaming laws), the profit element i.e. the rental returns over and above the return of principal can be designated as profit and remain unspecified.

The key here is that the bank can enter into an Islamic contract with the ticket purchaser to use his money to build real projects which are technically owned by the ticket purchaser and which the banks then leases from the purchaser (the rental contract that enables the bank, as an ordinary rental contractual counterparty, to guarantee a zero coupon rent—i.e. a rent that piles up and is repaid at one go in order to issue a guarantee of the return of the original purchase money at some point in the future. The Islamic bank will also declare itself a partner with the purchaser in the sub-lease of those properties leased by the bank to the real user of the properties for a rental over and above the rent the bank pays to return the capital—the profit element. The difference between the total rental the bank pays and the total rental paid by the sub lessee will be the difference between the banks cost of funds and the mortgage rate available to individuals in the market as this will work out as a mortgage as the sub lessee will acquire the property in the end of the loan. This way of contracting can be extended to numerous types of transactions and have for example included even the financing of multi-million forestry operations in Malaysia.

In reality neither the purchaser, nor the operator will see these legal constructions. The operator will receive his money, then under the abstraction method turn over an agreed percentage for example up to 25% of the purchase price on his behalf to the Islamic Bank, to be completely invested by them on his behalf. The Islamic Bank's name will be on the prize incentive bond ticket as the issuer who promises to pay the bearer his money back with profits (“for exact date of repayment see bank”). Nevertheless, the repayment would still be classified as a long-term event.

In this scheme, the overall pro forma contract between the bank and the theoretic player is validated by the Sharia'h committee of the bank and the prize incentive bond ticket for example reads on the back:

“Your money is returnable in full with profits for exact date see notice displayed in The bank of X validated by the Sharia'h committee of the bank of X and approved by Sheikh Y”

Embodiments of the present invention are now described with reference to the accompanying drawings.

### BRIEF DESCRIPTION OF THE DRAWINGS

FIG. 1 is a schematic diagram showing a first and a second different option for implementing a new type of transaction instrument;

FIG. 2 is a schematic diagram showing a system for handling a multifunction transaction of the first option of FIG. 1 according to an embodiment of the present invention;

FIG. 3 is a schematic diagram showing part of a proprietary system for handling a multifunction transaction of the second option of FIG. 1 according to an embodiment of the present invention;

FIG. 4 is a schematic diagram showing part of a non-proprietary system for handling a multifunction transaction of the second option of FIG. 1 according to an embodiment of the present invention; and

FIG. 5 is a schematic diagram showing the system and flows of information about the system of FIG. 2 illustrating the mechanics of how the system works.

### DETAILED DESCRIPTION OF EMBODIMENTS OF THE PRESENT INVENTION

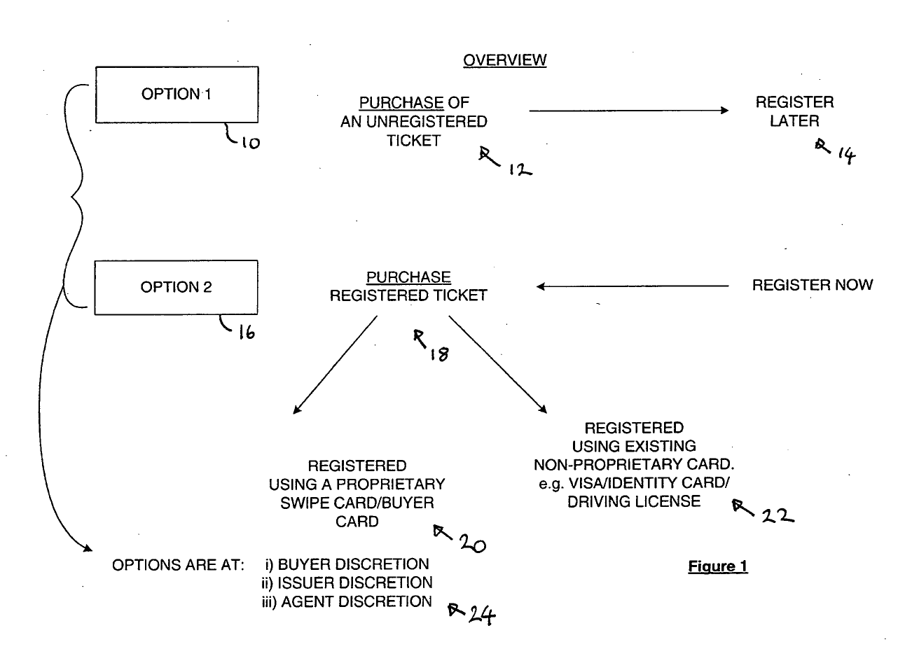

The present invention can be implemented in many different ways. Each of these involves a user interacting with a ticket-issuing terminal and the terminal in turn with a central server. The central server has access to information databases for the short-term (e.g. prize draw) function and a dedicated area of the central server and/or a dedicated server and/or an issuing bank server and database for the long-term investment (e.g. bond) function. This latter access can be either as especially dedicated adjunct to the prize draw database or through a communication portal to an existing an issuing bank server and database for the long-term investment (e.g. bond) function. This is described in greater detail below with reference to FIGS. 1 to 5.

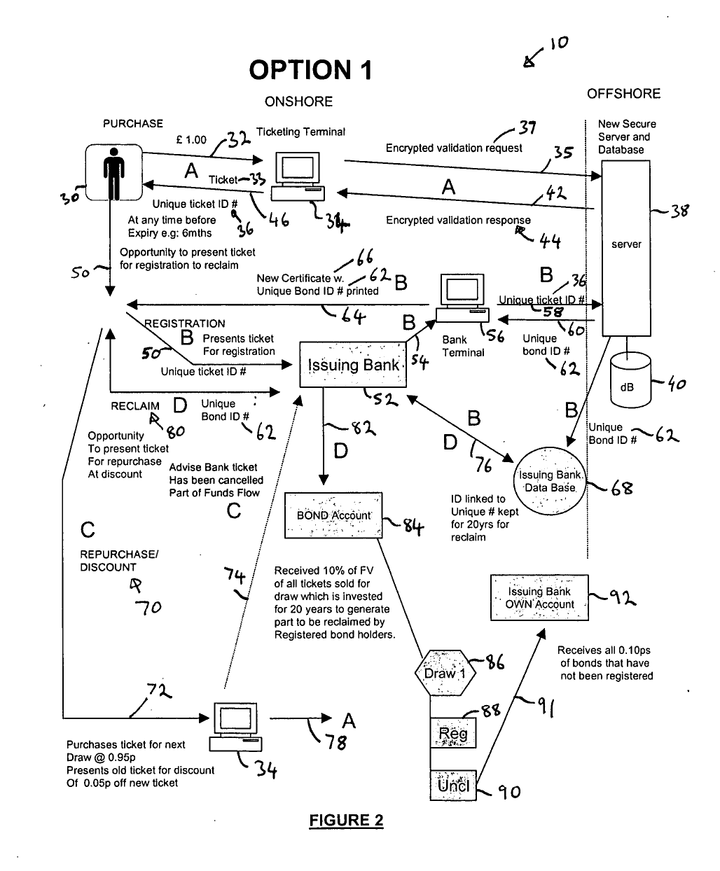

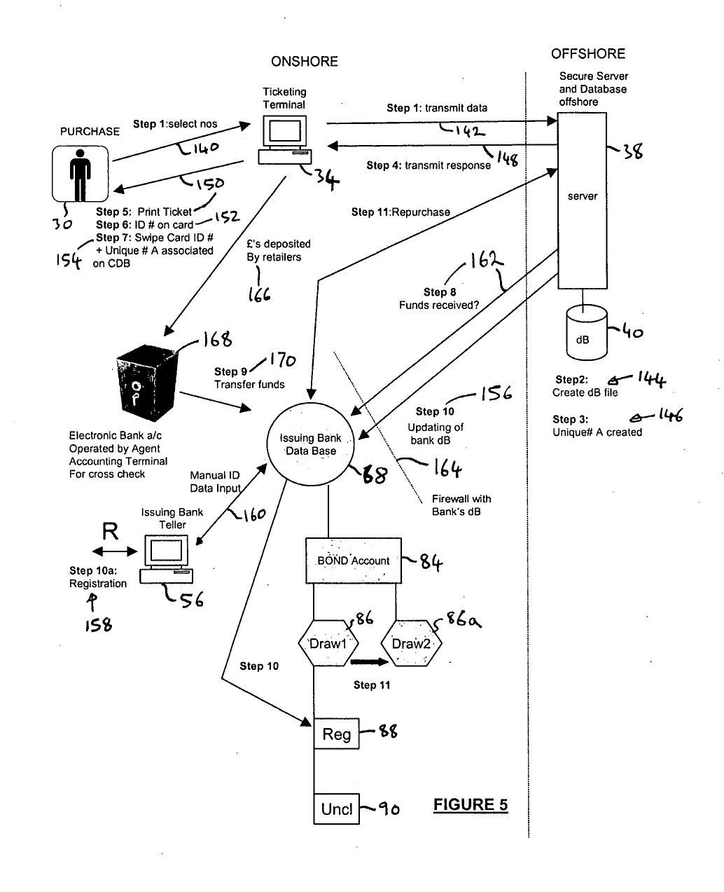

Referring to FIG. 1 an overview of the possible options (available embodiments) for implementing the present invention are shown. The first option (Option 1) 10 is a two-stage process in which the user purchases a dual-function ticket and in which the functionality is enabled in two-discrete stages. The first stage 12 involves purchase of the ticket and registration with the short-term event (prize draw) and the second stage 14 involves the user registering the received ticket with a banking institution or a dedicated registration facility. This is described in greater detail with reference to FIGS. 2 and 5.

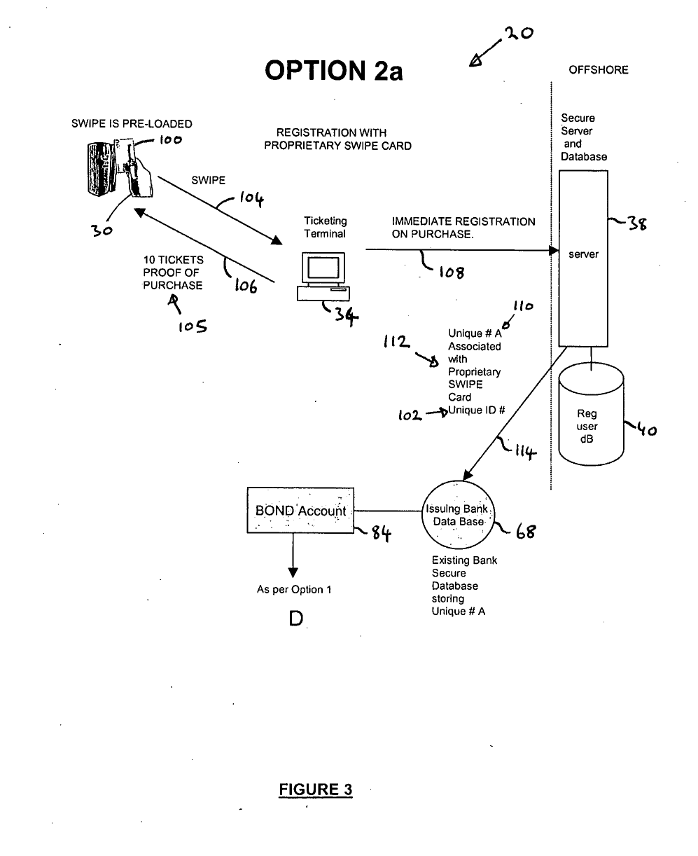

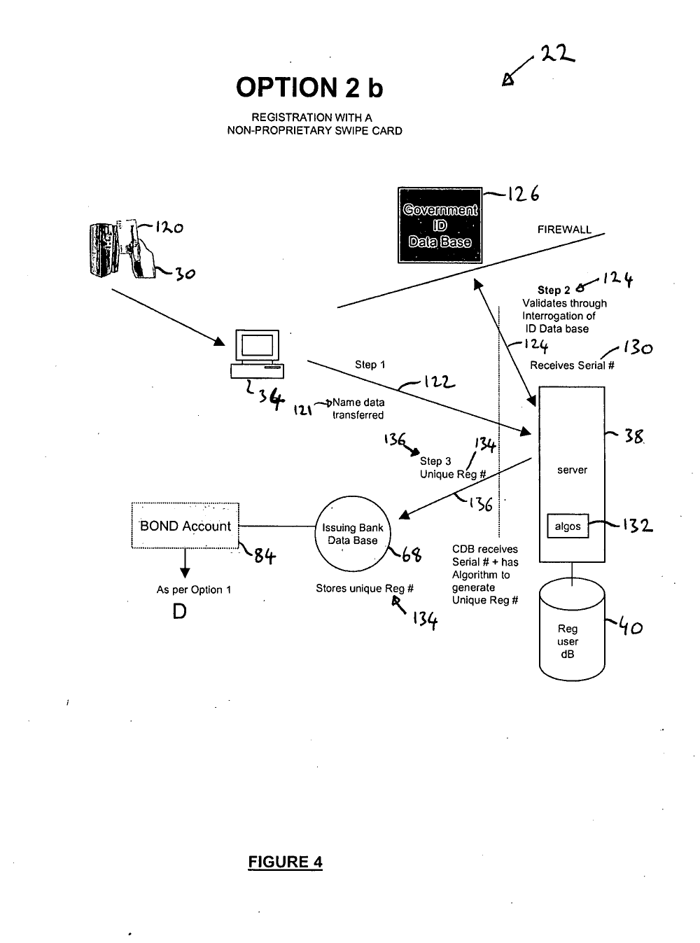

Another option (Option 2) 16 shown in detail in FIGS. 3 and 4, is a single stage process in which the user purchases at 18 a registered ticket which only requires the server to notify the bank of the purchase of that ticket. This option (Option 2) 16 has two variations (Options 2a and 2b). Option 2a 20 comprises registration and purchase of the ticket using a proprietary preloaded swipe/buyer card (or the like) and this is described in greater detail in FIG. 3. Option 2b 22 is registered without a proprietary swipe card, such as an identity card, driving license, credit card etc and is described in greater detail in FIG. 4.

Which embodiment or option is used depends on how the system is to be set up. Key factors 24 in deciding this depend on the buyer's (ticket purchaser's) requirements, the issuer's requirements and the agent's (ticket issuing terminal operator's) requirements.

Referring now to FIG. 2, and example of how Option 1 10 is carried out at a high level is provided. This two-stage process commences with the first stage 12 of a user 30 purchasing at Step 32 a new prize incentive bond ticket 33 for say $1.00 at a user terminal (hereinafter referred to as a ‘ticketing terminal’) 32. The purchase 12 may include the user selecting a set of draw numbers, for example, or specifying that the draw numbers are to be generated randomly by the terminal 34 and assigned to the ticket 33 being issued. The ticketing terminal 34 generates a unique ticket number 36, which is assigned to the ticket 33. The details of the ticket 33 including the unique ticket number 36 and the selected draw numbers (not shown) are encrypted at the ticketing terminal 34 and sent at Step 35 in an encrypted validation request 37 to a central server 38 which includes a secure offshore central database (CDB) 40. The central server 38 decrypts the received message 37, validates the ticket details and stores the details including the unique ticket number 36 and the associated draw numbers in the secure database 40. If the validation process determines the ticket request 37 to be valid, the validation is encrypted and communicated back at Step 42 to the ticketing terminal 34 in an encrypted validation response 44. There are numerous known ways of validating an issued ticket number 36 which will be well known to the skilled addressee such that this aspect of the embodiment is not described further.

On receipt of the validation response 44, it is decrypted and a ticket 33 is printed out at Step 46 for the user including the selected draw numbers and the unique ticket number 36. It is also possible for the ticket to be printed out at Step 46 with this information stored on the ticket in a machine-readable manner, such as in the form of a barcode or electronic data on a magnetic stripe of a card. This process 12 is labelled ‘process A’ and typically takes place very quickly, for example typically in four seconds.

Armed with the validated ticket 33, the user 30 then has a relatively short period of time, for example six months, to carry out the second stage 14, namely the registration process (labelled process B). Here, the user 30 presents at Step 50 his ticket 33 having the unique ticket identifier 36 printed on it to a bank 52 for registration. The ticket details 36 (including at least the unique ticket identifier 36) are entered into or read at Step 54 by a bank terminal 56 and the terminal 56 communicates at Step 58 the ticket details to the central server 38 incorporating the secure central database 40. A check is carried out on the server 38 and central database 40 to determine if it is a valid ticket ID 36. Assuming the ticket ID to be valid, the server issues a unique bond ID 62, which is transmitted back at Step 60 to the bank terminal 56. The terminal 56 produces at Step 64 a registration confirmation to the user and this can be in the form of a new certificate 66, for example which includes the unique bond ID 62 or other number from which the unique bond ID 62 can be determined on redemption.

The central server 38 also informs an issuing bank database 68 of the unique bond ID 62 associated with this customer's ticket 33 and the maturity date of the bond, so that these details can be stored for the long-term function, which in this embodiment is a long-term zero-coupon bond having a predetermined 20-year (from purchase) maturity date. The bank 52 may also input information to identify the user 30 by adding in his/her contact details for bond maturity (long-term event) and redemption in the future, in 20 years, in this example. This personal identity information (not shown) would also be stored in the issuing bank database 68.

For each prize draw that has generated bond entries, there will be a percentage of tickets that fail to be registered in Stage 2 14. The implications of this are discussed later.

In a much shorter time frame, typically a week or a month after purchase 12 of the prize incentive bond, the short-term prize event occurs. Here the user 30 can check to see if their entry into the prize draw, in this embodiment the form of selected numbers, has won the prize. In the event of the prize being won, the ticket 33 can be taken back to the ticketing terminal 34 and both the selected numbers and the unique ticket identifier 34 can be sent again to the central server 38 for verification as a genuine winning ticket 33 against the data stored in the central secure database 40. A verification code (not shown) can be generated and sent to the terminal 34 to authorise payment of the prize or to provide the means by which the user 30 can receive payment. Such validation of short-term event winning tickets is a well known procedure and need not be explained in further detail herein.

For prize incentive bond tickets that do not win the prize, the ticket 33 still has value as a long-term bond as described above.

The user 30 also has the ability to repurchase tickets 33 at a discount. In this process (labelled process C) 70, a long-term ticket 33 which has had its short-term function (prize draw event) fulfilled, can effectively be redeemed early (in advance of maturity of the long-term event) for credit against a new prize incentive bond ticket 33. The user 30 presents at Step 72 their ticket 33 for repurchase at the ticketing terminal 34 and for a $1.00 ticket 33 which has a nominal 10% long-term bond value, they may obtain, for example, a $0.05 discount against a new ticket 33 which would, in effect, then cost $0.95. This repurchase is communicated at Step 74 to the issuing bank 52 so that the database record in the issuing bank database 68 for that ticket 33 can be cancelled at Step 76 and the process continues at Step 78 as has been described in Process A with a new entry being made in the central database 40 for the prize draw event and a new ticket 33 being issued with its associated new long-term bond maturity date being say 20 years from the date of issuance of the new ticket 33. Again, this new ticket 33 would have to be registered at Step 14 as has been described above in relation to process B 14.

This repurchase process can optionally be replaced at the user's discretion (and/or the sellers predetermined choice as a general rule as an option in certain territories) with a straight cash sale process which transfers ownership back to the seller or to a third party and thus has a re-registration process whereby the original purchaser 30 receives the adjusted cash value and the third party is registered as the new owner for the purpose of redeeming the principal but not for receiving the prize as the short-term event has already occurred. This option exemplifies the nature of the multifunction ticket 33 in that it still has a value after its short-term event function has been exhausted. However, the requirement to re-register at Step 14 for the long-term event is always necessary with a change of ownership.

The reclaim process (process D) 80, involves the user 30 waiting the long time period (e.g. 20 years) before presenting their registration certificate 66 to the issuing bank 52. At this maturity date, the bank 52 then uses the unique bond ID number 62 on the registration certificate 66 to check at Step 82 its corresponding bond account record 84 (schematically shown on FIG. 2) in its database 68 and on confirmation of the validity of the registration certificate 66 and maturity of the bond, the issuing bank 54 pays the purchaser their original amount of their ticket purchase price (in the example, above this would be $1.00). Alternatively, the issuing bank 52 can decide (or pre-elect in principle) to payback the original amount together with any accrued earnings/profits if any. Additionally, the bank 52 may require the user 30 to provide some form of proof of identity, such as a passport and/or other form of secure identity document or secure identifier, to match with the possibly stored personal identity information.

The bond account 84 is partitioned into weekly draws accounts 86. For each weekly prize draw account 86, which has listed bond entries, there will be a percentage of bonds 88 which are registered correctly an awaiting maturity. There will also be a percentage of bond entries 90 which are unregistered. maturing bonds which fail to be reclaimed. These bonds are, after a certain length of time, cancelled and the funds accrued transferred at Step 91 to the issuing bank's own account 92. There will also be a percentage of unregistered bond entries 90 to which this transfer at Step 91 also applies. However, in the case of unregistered bonds, the transfer occurs after the end of the registration period of six months for example rather than on maturity.

Thus the bond account 84 is partitioned into a plurality of weekly draw accounts 86 each with sub-accounts for registered bonds 88, and unregistered bonds and unclaimed bonds 90.

Option 2a 20 is set out in detail in FIG. 3. Here the user 30 has a pre-loaded proprietary card 100, which for example, has a preloaded number of prize incentive bond tickets 33, in this example 100 tickets. Also the card 100 has a proprietary swipe card ID number 102. The card 100 can either be a pay-as-you-go card or a prepaid card. The user 30, in purchasing tickets, decides how many of the tickets 33 he wishes to activate and the prize draw numbers relating to those tickets 33 and enters these into the terminal 34 after swiping at Step 104 his card 100 at a ticketing terminal 34. Again the prize draw numbers can be generated randomly by the terminal 34 as in the Option 1 embodiment described above. Alternatively, the card 100 is a smart card with a PIN and is held within the terminal 34 whilst it is being read. For a PIN-enabled card, the user 30 has to enter his or her PIN in order to use the card and this prevents unauthorised use of a person's card 100. In this case, receipt data 105 (representing proof of purchase) can be written at Step 106 to the card 100 as is described below.

The terminal 34 provides some form of proof of purchase to the user 30, which is to be used for the redemption/reclaim process 80 on bond maturity. For example, the terminal 34 can produce a receipt ticket (not shown) for the user 30, or store an electronic file (receipt) on the user's card. The ticketing terminal 34 can also update the number of available tickets 33 stored on the swipe card 100, namely if ten tickets 33 are purchased, then the amount of tickets 33 remaining on the card 100 is debited by 10 tickets.

The terminal 34 performs a local authentication of the card 100 such as PIN processing and/or checking a card ID number 102 composition and provides at Step 102 the proof of purchase data 105 back to the user 30. The local authentication may include checking whether the number of pre-stored tickets 33 on the card 100 is greater than or equal to the number of tickets 33 that the user 30 wishes to activate in the current purchase. This local authentication is not described in detail here; as such techniques are well understood by the skilled addressee. Also the read data from the card 100 including its proprietary swipe card ID number 102, the prize draw numbers entered by the user 30 or selected randomly by the terminal 34 (user option) and an indication of which tickets 33 are being used, is all uploaded at Step 108 to the central server 38 and stored in the central database CDB 40. Here, a unique ID number A 110 (representing the unique bond ID number 62) is associated at Step 112 with the proprietary swipe card unique ID number 102. However, no other corroborating information is required in this embodiment. As such it is not necessary for the user to provide address details or bank account/credit cards details, thereby making the system very secure against eavesdropping fraud based on listening in on the data transmission to the central server 38. the ID number is very important to the system to identify the user by it is of very limited use to a fraudster.

The unique ID number A 110 is sent at Step 114 to the issuing bank database 68 for storage as the reference for the long-term event (redemption of the associated bond in, say, 20 years time). The unique swipe card ID number 102 together with the associated user details are also sent at Step 114 to the issuing bank database 68 in this embodiment.

The user 30 in this embodiment is pre-registered and as such his or her details are stored at the central server 38 in a registered user database 40. These details are linked to the unique swipe card ID number 102 of the user 30 and may also include the number of tickets 33 allotted to that card 100 at present.

In this embodiment, there is no need to carry out a separate stage of registration 50 of the user 30 with the bank 52 as in the first embodiment because the card 100 is a pre-registered card 100, for which the CDB 40 has associated user details (not shown) already stored in the registered user database 40 at the CDB 40. These user details are associated with the swipe card 100 and so can be passed directly to a secure existing bank database 68 of registered bondholders as part of an automatic registration procedure process. The bond-issuing bank 52 has access to the registered bondholders database (made up of bond accounts 84) and uses this for verification when a bond-maturity claim is made in a manner, which has already been described in process D 80.

In this embodiment, there are two possible alternatives for reclaim of the ticket amount from the bank 52 (on bond maturity). The first provides for the abovementioned proof of purchase 105 being the card 100 itself (or a receipt file on the card 100) and this has to be presented to a teller at the bond-issuing bank 52 to authorise bond redemption. (This would be similar to a bearer (pay-as-you-go) Oyster™ Card). The bank terminal 56 could simply use the unique swipe card ID number 102 to look up the user details stored in its bank database 68. Once the user authenticated their identity to the bank 52, the receipt data 105 could be authenticated as well as the maturity date of the bond, and the issuing bank 52 could then pay the purchaser 30 their original amount of their ticket purchase price (in the example, above this would be $1.00).

The second possible way of reclaiming the ticket amount is one in which the unique ID number 102 of the swipe card 100 acts as a reference to a central database 40 where the details of a bank account at the issuing bank 52 can be accessed (this would be similar to a registered Oyster™ Card). The difference between the first bond reclaim procedure described above and the second reclaim procedure is that no receipt data 105 is required for the authentication process. Rather, the bank's check on the authentication of the user's identity, by driving license or passport for example, would be sufficient. They may also require a local PIN number check to be passed as was the case for use of the pre-registered card. In this case, only matured bonds in that user's name are redeemed. Here the security is in the previous marriage of the unique number 102 of the swipe card 100 with the account 84 at the bank 52 using the unique ID number A 110, to which the bonds are allotted, e.g. Mr Smith's unique number 5 card has purchased 10; bonds on different dates.

Option 2b, as set out in FIG. 4, is very similar to that shown in FIG. 3 except for the fact that the CDB 40 does not store the user's details in a local registered user database 40, namely a registration carried out previously using a non-proprietary swipe card 120 can be used. In this case, the swipe card 120 or other machine-readable user-identifying information (driving license details for example) are used to identify the user 30 to the system and this identification information can be used to access the previous registration of the user with another system. This identifying information 121 is passed at Step 1 122 from the ticketing terminal 34 to the central server 38 and the CDB 40, where the user-identifying information, such as name data 121, is verified by interrogation at Step 2 124 of a government ID database 126, for example. Typically, there is a secure firewall 128 here which needs to be traversed, which may mean that no information other than a simple yes or no or a serial number 130 is received as a response to a user ID validation query 124. Assuming a serial number 130 is received in response to the user ID validation query 124, this is then applied to an algorithm 132 at the central server 38 to generate a unique registration (Reg) number 134. This unique Reg number 134 is then passed at Step 3 136 to the issuing bank database 68 as the verifiable user identifier.

An important point to consider here is that the user experience when using the non-proprietary swipe card or other machine readable user identifying information is similar to that of a proprietary swipe card. In other words, the user 30 simply has to swipe their card and the system determines how to access their previously registered information (be it proprietary and stored locally as in the previous embodiment or non-proprietary and stored remotely as in the present embodiment). Either way the procedure is relatively quick such that the user does not experience the lengthy time period with a significant amount of data entry associated with a user-registration procedure.

The reclaim procedure 80 at the bank 52 then is carried out as has been described previously, with the exception that rather than having user ID information in the bank issuing database 68 to authenticate a reclaiming user 30, only the unique registration number 134 is provided. This registration number 134 is used as a reference to the bond information associated with the user 30. Then user identity information, received at a reclaim event, is passed to the government ID database 126 to generate a corresponding serial number 130. This is then sent to the server 38 where the algorithm 132 converts it into a registration number 134 that is sent back to the bank database 68 and is compared to the previously stored Reg number 134. A match of Reg numbers 134 authenticates the user 30 for access to any matured bonds under this Reg number 134.

There are some variations possible in relation to the database 126 used in the process of creating the unique Reg number 134 described in FIG. 4. Option a) involves using a secure database 126 which is associated with an existing ID card database. This is the option shown in FIG. 4 but it may be varied by being able to obtain ID information from the database 126 rather than just a serial number 130.

Option b) is to use any ID database and to obtain name data from the database which is then passed on to the issuing bank database 68 as the Unique Reg number 134. Ultimately the bond needs to be issued to a person and so some way of linking to a person is required.

Option c) involves the swipe card data just validating that the person using it is authorised, and real. The bank database 68 is then provided with swipe card information to allocate to a registration database entry 84. On redemption of the bond 80, the information in the registration database 68 is presented back to the government database 126 for validation only.

A last option, which is also possible, modifies these systems to provide registration and terminal validation on separate systems for extra security against fraud.

Referring now to FIG. 5, the mechanics of how Option 1 works are set out in a diagram, which shows the system and the flows of information. Following the steps shown, the user 30 wishes to purchase a new prize incentive bond ticket 33. The user at Step 1 140 selects the draw numbers at the terminal 34 and pays for the ticket 33. The numbers may be selected in any way. For example, they could be marked on a machine-readable number choice slip, similar to that used in the National Lottery in the UK. The slip could then be scanned by the terminal 34, to determine the numbers. Alternatively, the draw numbers could also be entered manually into the terminal 34. Furthermore, the numbers could be randomly selected by the terminal 34 itself or even by the central server 38 and database (CBD) 40 and merely notified to the user 30 on verification of their ticket purchase.

Once the details have been read into the terminal 34, an encrypted electronic message 37 is created. The message 37 comprises 1) a terminal identifier, ii) the selected draw numbers if determined at or read into the terminal, iii) the time and date of the request and iv) the user's ID 102 if a swipe card 100, 120 is being used. This encrypted data is transmitted as part of Step 1 142 to the server 38 and database (the CBD) 40.

Here at Step 2 144, the received message 37 is decrypted, and a new data file is created for this ticket 33 and stored in the CDB database 40. The data file stores the decrypted information which includes i) the draw numbers, ii) the time and date of the request, and iii) a unique identifier A 36, 110, which is created at Step 3 146 using a stored algorithm 132.

The unique identifier A 36, 110 is then provided at Step 3146 either as a barcode (or other machine-readable code) for output back to the ticketing terminal 34, the barcode also providing other information required by the terminal 34. Alternatively, the barcode can be generated from an algorithm 132 to represent the unique identifier A 36, 110 and the other required information, and the barcode itself can just be provided for return to the terminal 34. This information together with the draw numbers is returned to the terminal 34 at Step 4 148 and the ticket 33 is printed out at Step 5 150 with the draw numbers and the unique identifier A 36, 110 (in a machine-readable format) or stored on the swipe card 100,120 in electronic format.

The user 30 then has the option to commence the registration period 50 at a time of his own choosing but, in this embodiment, within six months of purchasing the ticket 33. The first part of this, in the recommended secure a two-part registration process, requires Steps 6 and 7 152, 154 to be carried out. The user 30 can have a user ID number (Swipe card ID number 102) provided to them on a card, which is a reference to a user record held on the CBD 40. This information is provided for example by swiping, together with the unique number A 36, 110 of the ticket. This information is communicated back up to the server 38 and CDB 40 and the unique number A 36,110 of the ticket 33 can be verified and thereafter associated with the user's ID number 102.

In response to this, the server and CDB 38, 40 generate, using Algorithm 3 at Step 10 156, a unique number C 62, which represents the user's identity and well as identifying the unique ticket 33. The actual way in which this is generated is not important to describe as any algorithm 132 for generating the unique number from the relevant inputs could be used, and the skilled addressee will know many of these. The unique number C 62 is then transmitted back at Step 10 156 to the registration terminal 56 where it is printed on a new registered ticket 66 for the user 30, which represents the bond registration ticket 66, which is to be used for the second stage of the registration procedure at Step 10a 158.

The user 30 also has the option of registering at the issuing bank teller 56 directly with the ticket 33 they obtained from the ticketing terminal 34 at the end of Step 5 150 in a single-stage registration procedure 50. However, in this scenario, the user ID 102 would have to be given to the bank teller 56 who would also be responsible for completing the registration procedure for the bond. Whilst this can be achieved, in practice it provides a fraud opportunity for the teller 56 to manipulate the registration to a different person because a bank teller 56 could link in name details using existing bank technology.

Using the recommended two-part registration process described above, the teller 56 is unable to commit this fraud as the physical entry process 160 has to be linked to a pre-existing unique registration number C 62 which is lodged into the bank's system 68 and also printed on a special registration slip 66 by the ticketing terminal 34 which the customer 30 hand delivers to the bank teller 56 at the beginning of the second stage) of the registration process at Step 10a 158.

Jumping back to the first stage of the registration process, once the ticket 33 has been issued at Step 46, and the user ID 102 has been associated with the unique number A 36, 110 completing the first stage of the process from the user's perspective, the CBD 40 contacts at Step 8 162 the issuing bank database 68 (traversing the bank's firewall 164) at regular intervals to see if the retailers have deposited the money for the user's ticket 33 with the issuing bank 52. At some point, the retailers will deposit at Step 166 this money into their central bank account 168 and this will be transferred at Step 9 170 to the issuing bank 52 for the bond purchase. At this stage, the unique number A 36, 110 and the user's name can be provided to the issuing bank's database 68 for bond registration purposes. This data is associated together and stored awaiting the second stage of the registration process.

This registration ticket 66, containing the unique number C 62, has to be registered (in the second part of the registration procedure) within six months of the date of the original purchase. This process is carried out at the issuing bank 52.

On the second part of the registration at Step 10a 158, data is input at Step 160 into the bank database 68 and the numbers on the ticket (unique ID number C 62 and the machine-readable barcode on the original ticket 33 are sent back up to the CDB 40 and exposed to an Algorithm 1 132 and an Algorithm 2 132 for verification. The purpose of having two verification algorithms 132 is for enhanced security. Here Algorithm 1 may be kept entirely confidential and secure and access to it may be very limited. Algorithm 2, on the other hand, would be accessible by the bank 52 such that its inputs and outputs may be observable by the bank 52 but its interface to Algorithm 1 would not be externally visible. The actual algorithms 132 used for verification need not be described here as any verification algorithms 132 may be used and many will be apparent to the skilled addressee. As mentioned previously, unique Algorithm 3 at the central server 38 and CDB 40 generates the unique number C 62 and sends it back at Step 10 156 to the terminal 56. Thereafter, another new ticket 66 is printed with the unique number C 62, which confirms full registration of the ticket 33 and may provide instructions regarding redemption and repurchase.

At the bank database 68, the name of the person who owns the bond, the unique ID number A 36, 110 and the unique number C 62 are physically associated together in a database record. The record is related to a specific prize draw (draw event) and is deemed to have been registered. Each draw has its set of registration numbers associated with it and, on maturity; each draw will have registered claimed bonds and registered unclaimed bonds.

The repurchase procedure is shown at Step 11. Here the user buys a new ticket 33. The old ticket 33 is merely scanned transmitted up to the server 38 and CDB 40 and cancelled. Furthermore, the server 38 and CDB 40 notify the bank database 68 of this cancellation and issuance of the new ticket 33. A transfer is simply notified in the bond account 84 from the draw 186 to draw 2 86a.

Another embodiment of the present invention relates to the implementation of the multifunction ticket within a mobile telecommunications device. Here the user selection of an option or variable, as in the previous embodiments, can be made on the mobile device and transmitted via one of the mobile device's telecommunications channels, for example by SMS or e-mail, to a remote processing server. The user-selected option and mobile telecommunications address (mobile telephone number, for example) of the user's mobile device are stored at the remote server. Also payment for the entry can be handled by the mobile device using known techniques, as described later.

The remote server, on receipt of a valid ticket request and on confirmation that the ticket has been paid for, stores the user-selected option and issues a unique ticket number (as in the previous embodiments) to the user. The unique ticket number is transmitted back to the mobile device and stored therein for future reference. This stored number can be recalled later when required for registration of the user in the long-term event (in a similar manner to that described in the previous embodiments). Furthermore, where the user is purchasing many such multi-function tickets, the mobile device stores a plurality of the unique ticket numbers and distinguishes those that have been registered for the long-term event and those, which have yet to be registered. Also, the at least one user selected option for each ticket can be stored on the mobile device for determining whether the ticket has been chosen as a winner of the short-term event.

In order to implement this service on a mobile device, the user can either simply download an appropriate software application to their mobile device and install it, or the user can register with the remote server for this service (for example by use of a mobile or fixed internet connection) and as a consequence be sent the software application for installation on the mobile device. It is not necessary to describe the software application in more detail as implementation of the application will be well understood by the skilled addressee simply from a high-level overview of the software application's described functionality.

A further feature of this embodiment, which is unique and highly advantageous, is that once the short-term event has occurred and, for example, a winning ticket of a prize draw has been selected, the remote server can look up the mobile telecommunications address associated with the ticket number (e.g. mobile telephone number) and send a notification back to the mobile device of the user concerning the outcome of the short-term event. This notification can be via SMS or e-mail for example and persists on the user's mobile device until the user reads and deletes it. Therefore, if the user has been selected for a prize from the prize draw for example, this can be communicated back to the user such that they can claim their prize. This feature greatly reduces the problem of unclaimed prizes, due to the winner not becoming aware of the outcome of the short-term event.

Payment of the ticket purchase price ($1.00 for example) can conveniently also be made via the mobile device. In some countries, mobile telecommunications networks are being established faster than point of sale systems and other transactional systems. In view of this, the present embodiment is particularly advantageous for use these countries.

A monetary value can be loaded (via ticket terminals in shops/kiosks as well as through payments on the Internet) to a user's mobile device (or to a mobile user's account) to generate/increase funds available for spending/saving. This is termed a mobile device wallet system. These funds can either be saved or used to fund transactions normally effected by cash or credit card as well as in order to access the user's bank account and/or accept cash payments. These also have the added benefit of being able to fund transactions on the Internet not easily open to people not having bank and/or credit card facilities. They represent a safer and more efficient way for cash dominated/orientated economies/clients to effect cash-style transactions when it is either inconvenient to carry large amounts of cash or mandatory to effect an electronic means of payment, e.g. internet purchases etc. ‘Know your client’ and anti money-laundering requirements can be satisfied by an account opening process which accompanies such systems.

This type of mobile device wallet system is known and is not described in detail herein. However, a departure from the known systems, which is part of the present embodiment, is the manner of use of such known mobile wallet systems, which is described below.

Payment or the acceptances of payments are effected via a payments menu on the user's mobile phone, which is downloaded with the relevant electronic application when the user signs up for an account. Payment is made with participating outlets, which designate the shop owner's specific account identification number already held in the central system to allow the acceptance of payment from the customer's mobile phone account. The shop owner's ID code is entered into or read by the mobile device (for example by camera image capture of a bar code). The mobile device ID is also transmitted and used to access the user's account associated with that mobile device ID. The user may also be required to provide a PIN (Personal Identification Number) before the transaction can proceed. This can be transmitted in the payment request message or if a more secure system is required, this can be required locally before a valid message can be constructed.

Then the mobile device transmits the message containing the shop owner's code to the central computer via the mobile network. The central server looks up the user's account, determines whether he has the appropriate funds therein. Assuming sufficient funds are present, the shop owner's account is looked up using the shop owner's ID code and the server then generates and sends a communication (such as an SMS text signal or e-mail) to a designated number/receiver inside the shop which is connected either by landline or, where this is inappropriate, to a dedicated mobile phone that is the property of the shop owner/shop management etc. Real payment for the shop owner can be made either to a bank account (details of which are stored at the central computer) or to the shop owner's mobile phone. This allows payments to be made to small and medium enterprises (SMEs) that don't have developed banking facilities. For most, including remote landline inaccessible, shop owners, the payment that has been effected in this way will not only represent a convenience for the both shop owner and the customer, but will be potentially cheaper than the debit card/credit card/store of value card systems that are more technologically expensive or have larger charges to allow for default provisions.

If the mobile device is lost, the money associated with the mobile device is not lost with it as an internal access code is only known to the customer and only held on the central system itself. This makes it useless to the thief, except as a mobile device per se, such as a mobile phone. The whole account opening process can be redone and alternative mobile device validated to use the unused cash deposits. The mobile device will have a unique identity number attached with it, but this itself is useless without the second security measure, namely the client's PIN code.

Having described how the prize draw bond product would be used and how a system would operate in managing the interface between the prize draw side of the system and the bond side of the system, it is to be appreciated that the above described embodiments are exemplary only and that modifications will occur to those skilled in the art without departure from the spirit and scope of the present invention. For example, the long-term event has been described in the present embodiments as a long-term zero coupon bond. However, it is possible for this to be another types of long-term investment, which is preferably acceptable to Islamic teaching described above, for example.

Several specific products are now described which are related to the above described concepts but which themselves each have a unique advantage as a product over other similar products currently available on the market today. These products use the system described above, but vary other aspects of the solution. Furthermore, the attachment method of the ‘Abstraction Principle’ is described and embodied in some of the products described below.

The Products

With the partial exception of the Egyptian and other Islamic Premium bonds on which a considerable amount of work has already been done by the present inventor prior to this application, all the following products described herein after have a degree of interlinkage with respect to the fact that:

The Distribution Medium will dictate that some of the product features nominally common to a number of seemingly similar products will in fact be different for those nominally similar products, i.e. a fixed terminal network and/or a mobile phone distribution medium both depending on a central system database for registration of transactions as well as other calculations related to those transactions can only operate according to certain parameters some of which affect product features differently. Thus the product offered on a central system and terminal network may be different to one offered on a central system and mobile telecommunications network.

The Medium is the Product i.e. the distribution medium may be viewed in the eyes of the consumer as the product itself as with the mobile payments system described above and as Product Group G below.

The following products are each innovative of themselves. Each is directed to different aspects and combinations of aspects of the present invention as will be clear from a full understanding of this document. All of these products are believed to be acceptable to at least a part of the worldwide Muslim community by virtue of the abstraction method and/or the attachment method of implementing the Attachment Principle described previously.

Product Group A—Using Abstraction Method

Long-term financial instruments which underlie other financial and/or financial gaming and/or gaming products

These use the long-term financial instrument concept as an abstraction to a more traditional gaming product than a prize draw, i.e. a small percentage of the purchase money is put into a financial instrument in order to return the purchase money at some long dated point in the future (over ten years in time) so as to remove consideration from the general legal and Sharia'h definition of prize, consideration and chance.

Added to this abstraction method is the concept of any form of game such as the prize draw described above. The product could be a combination of any normal gaming product and the above described long-term financial instrument accessed by user ticket purchase and bank registration. Relatively newer gaming products can be used, such as financial market index betting products marketable for low-purchase prices in jurisdictions which traditionally regard “betting” money per point of movement of a given financial index as gambling and not as the financial instrument the underlying index is reflecting, thus not benefiting from capital markets legislation allowing the underlying financial instrument.

Given the intended wide distribution network and given that it is desired to benefit from the definition of skill-based activity, the product is preferably directed to financial market speculation products hence the kind of products tied to movements in financial markets as offered by index companies speculating on index movements, for example. This product is aimed at sophisticated markets in the developed world where the players would feel they have some understanding of how markets work and don't ordinarily have the resources to speculate on the markets, but would enjoy using their skills to leverage their return by investing a low stake on the direction of markets. In other words, i.e. for a dollar, the player could predict the up/down direction of the market whereby if correct they receive a multiplier return, but in the worst case scenario if they chose to they would have a stop loss of the one dollar so that it would not be necessary to go the traded option on the index route to contain the potential loss to the purchase stake, allowing the purchase of a “win it or bin it” ticket. However, in the typical and correct use of the ticket leading to registration of the long-term financial instrument (bond), which would result in no potential loss and this would take this product out of the impermissible category.

The option of dealing very inexpensively with the ‘know your customer’ regulations of financial markets could be provided either by swiping the user's national identity card that exists in many jurisdictions of the world or having a one-off account opening process or by requiring a registration of the long-term financial instrument (bond) sometime after each sale (and at a different location) to make the bond element viable. In reality, this would be at the customer's discretion, i.e. if he wants to make the bond part active in order to guarantee his money, or if he wants to collect his winnings).

In order to effect a transaction tied to an index, without using a traded option, a stop-loss provision would need to be effected limited to the size of the available stake. This means that the counterparty should be a gaming organisation that is effectively conducting a financial operation on one side of the transaction and laying off the other side in a gaming transaction in another jurisdiction in which this is allowed. This would, in effect, be using a gaming group to create a virtual traded option on an index.

Product Group B—Using Abstraction Method

Children's Characters Savings/Premium Bond Instruments

Premium Bond/Savings Bond Concept Based Products aimed at encouraging parents to buy on behalf of their children. These are thus aimed at being attractive to children who will persuade their parents, who must also approve of the underlying practical elements in order to buy it on their behalf, as in most jurisdictions financial instruments can only be bought on behalf of children by their parents acting as trustees.

The products in this category combine a savings and/or a prize/game concept and are constructed out of the following elements (both to be attractive to children and also their parents who buy it on their children's behalf), which may be combined to produce a premium bond/savings bond. Each ticket is a collectable ticket/card with a children's childhood story character. Purchasing each card not only fulfills the collectable game, but also enters the player into a prize draw. Furthermore, the ticket price is fully refundable via the long-term bond discussed previously. Parents normally tend to either go for low-risk or long-term growth potential type investments when making savings decisions for their children and the product is tailored to this point.

However, at the insignificant prices these products are issued at ($1.00) and with the encouragement from the child looking for the collectible card and the bonus toys, this is not truly designed to compete with other savings decisions made by parents on behalf of children. It is an impulse buy by a parent with accompanying children at a point of sale, where children will be agitating for a number of things a parent may think unbeneficial i.e. sweets, and the parent is motivated because this buy as opposed to other “not good for you buys” carries savings benefits and the chance of winning a prize! Although this is a new product which may make parents diverge from their normal savings decision pattern on behalf of children. It is also possible to seek to match the normal parental investment pattern, by reducing the prize winning opportunity, i.e. devoting more of the purchase price to the underlying savings instrument which thereby exceeds the simple return of the purchase price and rather delivers back a greater savings element. For example a $1 ticket could return back $2 in 20 years, provide a collectable card and also give the player a chance in a prize draw.

Looking now at this product in greater detail, it can involve a rechargeable card (reprintable plastic card) customised in the appearance of a favourite childhood character all with elements from a favourite childhood story—thus for example a Harry Potter Gringott premium bond, a Gringott being a single currency unit of whatever country they are sold in. A single Gringott will thus be a savings/premium bond with a respectable return and/or a prize.

Each childhood character or item from a childhood story will be matched to the underlying investment vehicle according to the indications of market research. Thus a Harry Potter Wizard could contain a stock market-based underlying vehicle whilst a ‘Dark Lord’ or a ‘Voldemort’ could contain a highly geared commodity vehicle for example.

These products are ideal for impulse buys made by parents on behalf of children where parents are particularly receptive to the demands of their children, i.e. family restaurants, children's bookstores, supermarkets, newsagents, dress shops, children's clothing shops and toy shops. They can also be made available in banks and other institutions where parents may think wistfully about savings for their children. This leads to the idea of combining the central systems of a gaming company with the terminal distribution network of AMEX, Barclaycard and other card payment systems which already have a wide terminal distribution network in the above type of establishments, most of which, with the exception of supermarkets and newsagents, are not normally used for prize draw ticket distribution and hence don't have prize draw ticket terminals.

With the above example of a Gringott, every purchase of say 10 can also entitle the child to some purely toy item. The child is thus attracted to the collectable nature of the card itself on which is registered the bond as well as the toy, which the purchase of an individual Gringott and/or several Gringott's entitles the purchaser to.

A commodity/stock market combined investment vehicle may also be utilised for the long-term bond.

Product Group C—Using Abstraction Method

Online Gambling Site Premium Bonds/Prize Schemes

This is a loyalty scheme aimed at online gamers which dictates that as long as a certain amount is held in an online gaming account then that amount can enter a prize draw on a normal premium bond style multiple draw basis. There would have to be a minimum period in which this amount—here notionally $100, could not be pledged for a gambling transaction so as to allow it to build up an interest generated prize pool before the bond could be “put” (i.e. sold back) to immediately fund a gambling transaction that lost. A minimum amount that has to be held for a minimum period which is itself lower than the minimum amount required to enter the scheme could be required—the difference between the two being utilisable for a gaming transaction. By linking up with online gaming sites the terminal network can be used where jurisdictions permit to take payments to lodge in an online gaming account for people who wish to access Internet gaming but don't have credit/debit card facilities that allow them to do this.

Another product to which the present invention could be applied is a sports-related product in which a sports-result forecasting process which generates a series of numbers of skill-based selections of win/lose or draw options could be used as an alternative to a prize draw incentive. One particular popular area of application would be for football result predictions.

Product Group D—Using Attachment Method

1. Premium Bond/Financial Instruments which Underlie Other Financial and/or Financial Gaming and/or Gaming Products

These use the premium bond/financial instrument concept as an attachment to a more traditional gaming product than a lottery i.e. a small percentage of the purchase money is put into a financial instrument in order to return the purchase money at some long dated point in the future so as to remove consideration from the legal definition of prize, consideration and chance. These premium bond concept-based products are thus aimed at sophisticated non-Muslim purchasers (and those Muslim purchasers, who would regard the use of skill and return of purchase money as sufficient to render this as non-gambling).

In particular, apart from normal gaming products, this use of the premium bond/financial instrument concept as an attachment can be used to render relatively newer gaming products such as financial market index betting products marketable for low-purchase prices in jurisdictions which traditionally regard “betting” money per point of movement of a given financial index as gambling and not as the financial instrument the underlying index is reflecting, thus not benefiting from capital markets legislation allowing the underlying financial instrument.

Given the intended wide distribution network and given that it is desired to benefit from the definition of skill-based activity, the product is preferably directed to gaming products that reflect financial markets hence the kind of gambling products tied to movements in financial markets as offered by the index companies betting on index movements, for example. This would be aimed at sophisticated markets in the developed world where the players would feel they have some understanding of how markets work, don't ordinarily have the resources to play the markets, but would enjoy using their skills to leverage their return by betting a low value stake on the direction of markets, i.e. a dollar bet on the up/down direction of the market whereby they received a multiplier return, with a stop loss on the one dollar so that it would not be necessary to go the traded option on the index route to contain the potential loss to the purchase stake, allowing the purchase of a “win it or bin it ‘ticket.

With this product, the operator would be effectively acting as agent for companies that presently offer financial index based gambling products with them handling all the offsetting and hedging and selling and providing an accounting function.

The option of dealing, very inexpensively, with the ‘know your customer’ regulations of financial markets could be provided either by swiping a national identity card that may exist or a machine readable driver's license or having a one-off account opening process prior to the sale of the gaming ticket or by requiring a registration of the premium bond sometime after each sale (and at a different location) to make the premium bond element viable. In reality, this would be at the customer's discretion, i.e. if he wants to make the bond part active in order to guarantee his money, or if he wants to collect his winnings).

In order to effect a transaction tied to an index, without using a traded option a stop-loss provision would need to be effected limited to the size of the available stake, meaning that the counterparty should be a gambling organisation which is effectively conducting a financial operation on one side of the transaction and laying off the other side in a gambling transaction in another jurisdiction in which this is allowed. This would, in effect, be using a gambling group to create a virtual traded option on an index.

2. Retail Based Financial Products that May or May not Use Underlying Premium Bonds Depending on the Jurisdiction.

This is a so-called hedge play is known as a Hedgelet bought over a ticket registration and realisable in x period of time (the data holding period of the system). It is aimed at small consumers and businesses who wish to insure themselves against price movements against them over a basket of assets that they ordinarily consume—for example a taxi driver/small business consumer with a personal income of $10,000 and $30,000 worth of business expenditure on petrol consumption (or any other large consumable subject to rapid sudden unexpected price rises) per annum may wish to, but be unable to at present, to insure against rises in excess of 10% in the petrol price. Here a notional figure of 10% is used when in reality price rises are only significant and truly hurt (prompting a search for relief) when they are operatively rising at a percentage above that level where his profit margin decreases (in a fixed price taxi fare market) to the point where it is not a question of disposable income on relative luxuries, but mandatory income to provide sustainability of normal existence or worse still to live hand to mouth).

Thus imagining that a customer makes 30% of the petrol price consumed as his profit and he absolutely needs 20% of the petrol price consumed to feed his family and live he may be willing to trade 3% of the petrol price (i.e. cut his income by 10% to 27% of the petrol price to guarantee it in the next year) for a traded option/hedgelet that gives him cash back for a sustained petrol price rise up to a certain amount above a certain floor for a certain period. Here advantage would be taken of the spare capacity of the system to book smaller retail transactions for esoteric financial products that are re-engineered to cover a basket of consumables that small retail customers are frightened may go up such that they wish to effectively effect crystallise their potential losses to the trade-off purchase price of the hedge.

Because the spare capacity on the central systems is been reviewed for use as well as the already relative cheapness of booking and administering results of those central systems, already existing esoteric financial products (normally used by big consumers to hedge their activities) can be repackaged to supply tailored versions of these to the retail market. Here the system ties up with a financial institution and effectively only acts as a booking and administration agent for a transaction fee, i.e. only booking the data transaction in order to create a smaller cost retail product rather than actually taking the exposure itself. It should be noted that several institutions are already using the relative cheapness of the internet to create these so-called Hedgelets to bring them in the range of $100 accounts and $10 trades for smaller retail investors.

Product Group E—Using Attachment Method

Money Transfer Products Combining Lottery Elements

Product 1

Here the terminal network and central systems are used to transfer money between different jurisdictions for a flat low fee in comparison to money transfer bureaux such as Western Union and banks. Technically, the transfer agent, as a promotion, has part of his commission fee placed into a prize pool. Hence, a charge of the cost of the transfer plus a nominal amount, say $1 which effectively purchases a specifically designed lottery product, is used. Thus, for example, if a fixed transfer fee were say $5 in reality the fixed fee that would be offered to the customer would be $6.

The purchase of the lottery ticket would be made via the terminal at the transfer agent which could operate as a conventional lottery terminal, enabling the user to select lottery numbers for the draw or have them selected automatically. Alternatively, a dedicated money transfer terminal could be provided and be adapted to include the additional functionality of a lottery terminal.

The customer is thus offered the opportunity to transfer his money at a vastly cheaper rate than existing transfer bureaux or the banks whilst at the same time getting the opportunity to win a lottery prize that is extremely large, potentially larger even than local rolled over lottery prizes as it would be multi-jurisdictional.

The nominally expensive in labour and resources ‘know your customer’ anti money-laundering requirements of many jurisdictions would be satisfied at cheap monetary cost by requiring a one-time registration process, potentially where required at either end, prior to the first transfer of money, allowing for an account generation card to be provided to the user. This card would not have to be present to enact a transaction at either end, both parties would merely need to have the unique identity number generated at the registration process and the number could potentially correspond to some identity document.

In countries with developed identity card systems, the ‘know your customer’ requirements could be tied with card readers and use machine-readable national identity card details as the identifiers. Alternatively, some other form of machine-readable identity information such as a driving license details could be used.

The potential large cash availability requirement to pay transfers could be overcome by bringing in secondary banks that normally don't have a high exposure to the lucrative foreign exchange market and requiring them, in return for their share, to have a terminal in their local branches where they could make payments in local currencies. This use of secondary banks as local partners would have been facilitated by the potential use of banks as vending points for other products such as premium bonds and ensuring that as part of the consideration to allow them to do this, they agree to act as cash register for the money transfers.

This product would be acceptable under Islamic considerations as the prize is coming out of the transaction fee charged for a legitimate economic transaction and the prize would be considered to be given from a percentage of the fee as a marketing strategy.

It would also have the advantage of being acceptable in most legal jurisdictions around the world as it is possible to legitimately claim that this is part of a genuine economic transaction in which a prize is offered as a marketing strategy. This system is potentially very much cheaper for money transfer than the banks or transfer bureaux because of the relative vastly lower data and other costs. Accordingly, the addition of the $1 in the fixed commission fee in order to generate the prize would not be felt by the customer.

Product 2

A second variant described below would also be very popular in the Islamic world as it would fulfill the charitable requirements of Islam and give individuals the chance to win a prize and would be a truly powerful prize draw product as it doesn't involve the complicated constructions related to premium bonds. This product would involve a money transfer but would also involve the purchaser transferring a minimum donation to a charity foreign to the jurisdiction in which they are in. Hence the variant would be engendering the genuine requirement for a money/foreign exchange transfer charge, allowing a fixed fee to be charged for money transfer and then giving access to a multi-jurisdictional lottery pool. This is acceptable in Islam because the genuine seller of an economic good, which is the sale of foreign exchange as part of the transfer to the foreign charity, is technically using part of its own profits not the purchaser's own purchase money to generate a prize as a marketing strategy which is permissible. Furthermore, because the purchaser of the charity transfer product is actually fulfilling one of the Islamic duties under the five pillars of Islam this moves the transaction to the highest ranking in Islamic law.

In the case of this charity-based product, it would be an advantage to have a free draw list of associated validated terrorism-free charities that could be said to be “worked with” like the Red Crescent etc. which would allow compliance with antiterrorism and anti money-laundering legislation.

Product Group F—Using Attachment Method

Real Estate Based Products

These fall into two groups both of which can have a prize element attached, by putting some of the purchase price towards a prize pool. Both types of these transactions can take advantage of the mobile phone payment systems outlined in Product Group G below.

Product 1

Hotel Room Purchase Product

This is an Islamic financial product aimed at the poorer members of the retail market who would like to take advantage of the boom in tourism in their local markets but lack the resources to buy into hotel shares, or are prevented as Muslims from buying these as these are banned in Islam as hotel shares contain tainted earnings as the profits are commingled with profits from gambling and alcohol sale related activities of the hotels.

The concept is the fractal as opposed to outright ownership of individual or groups of individual hotel rooms. The mechanism is to have a holding company that takes an option on title to hotel rooms (but not restaurants and bars within the hotel so as to remain within the strict Islamic prohibitions against pork, alcohol and gambling) and then sells participation in the ownership of itself on a partnership basis for single currency units in whatever jurisdiction it is in. The option aspect is to enable no real funding to be required between the listing of the hotel rooms for purchase and the time delay that occurs before eventual cash purchase by the terminal network customers. Part of that single currency unit can be put into a prize pool. The remaining part of that single currency unit after deduction for fees and costs is transferred to the holding company account which in turn is transferred to the hotel owner for the rolling execution of the option and the real property transfer of a designated amount of rooms.

Part of the condition of the hotel room purchase agreement in small hotels could be that account management systems could be placed into the hotel concerned, which potentially could be in the form of screens/keyboards and software/communication links to satellite uplinks to central servers, which in turn would be interfacing with the larger hotel management systems that already exist in the market. These new systems and/or interfacing software would handle all payments in the hotel and allow the management charges and a general ownership charge to be deducted from all incoming receipts. The nightly rate on the rental of the room is split between the holding company and the hotel owner according to a pre-agreed percentage and the money enters into the account of the holding company which publishes on a quarterly basis or monthly basis which allow the ticket purchaser to realise his profits by selling his ticket to a financial institution which will act as market-maker for a bid offer spread very much as in the unit trust industry.

Again since the prize is being generated out of the manager's management fee then it is regarded as Islamic as it represents a marketing incentive as offered by the manager of a real economic transaction. Accounting control problems can be avoided by requiring an option to purchase all rooms and only booking the hotel is purchased once our network customers had bought all the rooms. Management charges would be applicable only to management's portion of a set fee, i.e. a percentage of total room rental proceeds. The system would not thus have to account for hotel charges, merely access the record of occupancy and corresponding room rental income.

Product 2

House Auction Product

The following steps are only relevant to market professionals the general public sees a listed house and is invited to bid for it at whatever price they wish.

Step 1

International houses are listed on our dedicated internet site by our various partner Realty Firms (Estate Agents), together with a unique identifying code number, and are pictured on the Internet/dedicated “House” satellite television channel and offered for auction, the bid to be registered on Internet/mobile phone on the basis outlined below. New houses enter the frame/are offered at the start of every week/2 weeks/appropriate period as dictated by market research and prevailing conditions in the ‘High Desire’ international/local purchase market. The deciding criterion of which market and which houses is that which produces the relatively widest possible overlay of a high stock availability in a given market on the one hand with a real desire to purchase in those locations on the other. Un-sellable houses are only to be undertaken if they are un-sellable because of a mis-pricing i.e. “dream homes” that are ordinarily too expensive for a given market for our target consumer will, because of the nature of the product be viable for offer under this product plan. This product can work for new build projects where developers want quick market clearance as well as old build multiple and single family unit occupancy developments.

Step 2

Four binding values per individual house are set, only one of which is revealed to the public. Step 2 actually precedes Step 1 as this revealed value is listed at the same time as the House is on the Internet site.

These four values are:

The buyback value or the value which a finance house pre agrees to “buy back” the house from any successful bidder who opts not to complete the purchase i.e. not pay the money and take possession (in reality the paper buyer is being bought out of his option to purchase rather than a real transfer taking place, the real transfer takes place between the finance house and the seller). This buyback value is made available to the public. This value is theoretically the professional valuer's market perception of the clearing price of a house minus the projected cost of funds/sale for the projected forecasted period between purchase by the bank and resale by the bank minus an extra risk margin. This value could, theoretically in a prevailing interest market of R % and a house clearing price of Y % of market offered price and a C % cost of sale and a P % risk premium, be Offer Price * (Y−((Y*R)+(Y*C)+(Y*P))). Note “bank” here also mean a new specially set up special purpose vehicle company funded by bank debt to buyback houses at a marked discount to their market value and then sell them on the market.

The minimum reserved value or the value at which the house owner must accept all offers and corresponds to the price the seller could have reasonably been expected to make by selling his house on the open market before paying realtor/estate agent fees. This is not a price imposed on the seller but effectively what the seller is willing to list the house at having taken independent advice and then negotiated with the partner Realty firm. This price, i.e. minimum reserved value, is not declared publicly for obvious reasons

The ceiling value or the value above which non-completed/non-cash bids, (i.e. bidders hoping to access the finance house buy back option) won't be accepted. This also is not declared although the percentage of the bid ticket allocated to this transaction can be declared. In other words, if the actual monetary ceiling value is the sum of percentage of the bid ticket registration purchase permanently allocated say (30%) to this ceiling value and then the proceeds of 30% of the bid ticket sales are attributed to a particular house in money terms according to the number of bids for that particular house the market cannot calculate how many bids have been made for a particular house, only the central system can. The percentage value is set to be equal for all bids for all such houses and this does not reveal the actual ceiling value, which is used as a deciding point between cash and paper buyers. Both have an equal chance of effecting the purchase depending upon the popularity of a particular house and how many bids whether for cash or paper. Obviously some houses will attract paper bids and some will attract cash bids. However, the market can be seeded some time before the close of the auction towards one type of buyer, i.e. cash or paper, as long as this is carried out openly by declaring some of the monetary value actually reached to date in attributed bid registration that an individual house has attracted to date.

The attributed cash sale value which is the market value of the house which is calculated by a market professional minus 10% of the proceeds of ticket purchase or whatever is allocated to the seller and is the price at which or above which all real cash buys trump all non-cash buys. For explanation of how this works see below.

What Actually Happens (Example)

The seller agrees to sell his house at the minimum reserved value which will include as a minimum the proceeds of sale plus 10% of the bid ticket registration value if any, there theoretically being no fixed monetary maximum total return to the seller, just what the market will bear in terms of attracting bids, each bid requiring a one US dollar bid registration ticket, of which the seller gets 10% of the proceeds of. As there are no estate agent fees, there is already a selling gain to the prospective seller, as the minimum reserved value that the seller agrees to will no doubt be the market value minus estate agent fees. The seller will in all cases get 10% of the proceeds of the bid registration ticket purchase attributed according to a number of bids for his house so in theory could put his house up for sale at a minimum non publicly declared reserved value, not be obliged to sell as this minimum is not reached (the realisable sale proceeds being calculated on the basis of the 10% bid ticket proceeds plus the actual bid amount) and still pocket a healthy profit whilst still having a house to sell at 100% of its market value in the normal way. If there are a large number of bids for the actual house generating a high monetary amount for the attributed 10% then the buyer also gets a good deal as some of these attributed percentages will reduce the minimum reserved value element that has to be funded from the actual purchase. For example, a house with the real market value of $100,000 that receives $40,000 of attributed ticket bids and bid amounts of $60,000 from a prospective buyer can be sold to that buyer for $60,000, a substantial discount to the real market price as the seller has received proceeds of $40,000 from the ticket sales and $60,000 from the buyer. As this represents a real economic transaction conducted at a substantial discount, it is both attractive to Muslims and not Muslims throughout the world.

The Actual Process (Example).

The potential bidder sees a series of houses on the Internet/dedicated satellite channel, decides to bid for them and buys a $1 ticket bid registration ticket from the terminal network which gives a unique code which he uses on the Internet or on a mobile phone/push button phone landline to register his bid amount on the basis of one ticket one bid. This bid which is attributed to the unique house code number displayed with the house is registered on the central system. The bidder has to indicate at the time of the purchase of his bid registration ticket (which gives him his unique number to register the bid on the Internet or by mobile phone), by ticking a box on the purchase slip used to generate the bid ticket (which in technical terms exactly resembles the purchase slip allowing customers to pick numbers which then a ticket terminal reads and then generates a prize draw lottery ticket), whether he is a cash buyer or paper bidder.

10% of the $1 is allocated to whichever house that particular ticket holder bids for on the basis of 1 ticket 1 bid. The bidder knows the minimum buyback value, the ceiling percentage, but can only take an educated guess at the other purchase values in monetary terms.

The winner is either the cash buyer with the highest bid in monetary amount or the paper buyer with the highest bid in monetary amounts. This case requires that the paper bid is below the ceiling value. Where there are no paper bids below the ceiling value greater than the cash bids, the cash bids win.

The winning bid is declared and in the case of a cash bidder he is given one month to come forward and pay a 10% of his cash bid and three months to complete his transaction. These property purchase completion requirements will be varied in respect of cash buyers according to the normal practices of the jurisdiction in which the property is being sold.

In the case of a winning paper bid, the bidder is given one month to come forward and complete the transaction. However the bank reserves the right to adjust the buyback value downwards if there have been any adverse movements in the property price between the bid and the actual completion of the paper purchase. Again, there may be some variations according to the property market purchase requirements of a given jurisdiction.

In jurisdictions which don't allow such auction registration charges, some of the proceeds are allocated to a premium bond to return the $1 plus a prize/or an interest earning according to legal requirements. In jurisdictions which allow for it, a lottery draw can be included on the ticket number or even chosen numbers, which are chosen in addition to the machine generated bid code.

The remaining amounts of the $1 are divided between operator/valuer/finance house/etc with the matrix reflecting an overlay of consumer sentiment re prize size/maximum premium bond retention periods etc against capital market and other financial legal restrictions. Nominally expensive “Know your client” and anti money-laundering registration process difficulties are satisfied at a relatively cheap cost by a one-time account opening process which generates either an identity card entitling purchase or a rechargeable card on which bid codes are recorded, or an account number tied to a national identity document, whichever is the cheaper technical solution. Alternatively only a unique non-changeable ID number on the account identity card can be required to be hand entered on a terminal/mobile phone without the account identity card being present allowing for impulse buys to be charged on the basis of $1 one bid, as long as the client remembered his identity number.

The non-cash buyer is bidding against real buyers who want to actually purchase at discount to the real market price and are trying to take advantage of the failed bids generating enough revenue from the 10% of attributed bid registration tickets to allow for a substantial discount to the real market value.

The non-cash buyer who successfully bids closest to the ceiling value receives the cash value of his bid minus the minimum buyback value from the bank as long as the minimum contract value has been satisfied from the 10% proceeds. The ceiling value will operatively be 30% of proceeds of bid ticket registration or whatever is allotted plus the minimum buyback value so that the cash back for non purchases doesn't leave the bank out of pocket, —i.e. the bank is only committed to buy the house at the discount ratio to the market value calculated as above. The option exists if it is considered that the co-mingling of paper and cash bids it is harmful, to separate cash and paper bidders by means of the ticked box generated at the time of the bid ticket purchase. Thus some houses can be designated as only available for paper bid, some houses only available for cash bid and some houses available for both.

The non-cash buyer who is reality only a paper bidder, is risking that if his bid is below the ceiling height, which he doesn't know, but above the attributed value i.e. the real market value minus the 10% proceeds that a real cash buyer, who comes in at the same price as the paper bid or above, might be able to trump his bid and complete the purchase.

Although this paper-based bid part of the process is a skill-based exercise on the one hand and a real economic transaction on the other, depending on whether you are an intended real or a paper bidder, both the paper bidder and the cash bidder exhibit various very interesting emotional elements including an exciting sense of gambling, getting something for nothing, the possibility of buying real property for personal use/investment at a substantial discount to the market price. The cash buyer is thus looking to make a substantial saving on a real purchase, whilst the paper bidder is in effect looking to calculate though his perception of the property market including house prices in a given market, the price at which he can win the paper bid transaction and get paid the difference between his paper bid price and the buyback value without actually purchasing anything.

The paper bidders, who are in a sense players in a game of poker, which in this case has all the aspects of poker, but is in fact a real game of skill and judgment not arbitrarily dictated by the drawing of a card, are using their skill and knowledge in the property market to make judgments as to the real value of property and the likely markets propensity to purchase a particular piece of property. A high market propensity to purchase a given property, something a property market professional would believe that they are well placed to judge, would thus engender lots of bids and a very high ceiling value, to make high returns potentially available to a property market professional for a one dollar investment.

This can be illustrated by the following example. A house offered for world-wide bids on the Internet and worth $100,000 on the open market, with a buyback value under this project of $60,000 receives a million bids. This represents $300,000 in attributed bid registration proceeds which are available to the finance house to purchase the option to buy from paper bidders. The ceiling value is thus $300,000. A paper buyer bids $299,000 the bank pays him $299,000 minus transaction costs of him buying the house funded by them and him selling it back (in some jurisdictions this two-way paper process may be necessary to avoid the transaction not be termed a real property transaction and attracting gaming restrictions), all of this funded by the attributed bid registration proceeds. The paper bidder will have made a profit of some $299,000 or so (i.e. minus house purchase transaction costs) for a one-dollar investment or potential loss.

The seller receives the buyback money from the finance house of $60,000 plus 20% of the attributed bid registration proceeds or $60,000. The finance house, or the special purpose vehicle the finance house is loaning money to, now owns a house bought for $60,000 which is worth $100,000 on the open market. The seller's full return is $120,000 for his house, which is worth $100,000 on the market and pays no estate agent fees. Obviously, if paper bidders don't go in for a particular property, the bid registration proceeds fall, as does the ceiling value, as does the attributed sellers value thus the pendulum swings over in favour of the cash buyers. There exists a ready market of paper bidders amongst market professionals and people who feel they understand the property market or at least feel they can find out something about the property market in which a particular house is being listed.

As sellers and buyers all come out ahead because of the proceeds generated by the underlying bid registration process, this product will be attractive to all sides of the house purchase process, whilst at the same time generating liquidity by bringing in proceeds from paper bidders who are in fact non buyers in the real sense of the word.

It will also be attractive in areas and countries where affordable housing is an issue as housing will be purchased for a substantial discount to its market value.

Product Group G—Using Abstraction Method

Mobile Phone Payments

These have been described in earlier in the description. They load cash (via ticket terminals in shops/kiosks as well as through payments on the Internet) to a user's mobile phone to generate/increase funds available for spending/savings. These also have the added benefit of being able to fund transactions on the Internet not easily open to people not having bank and/or credit card facilities. They are aimed at clients who have poor/nil access to bank accounts and/or credit card/debit card facilities. They represent a safer and more efficient way for cash dominated/orientated economies/clients to effect cash style transactions when it is either more convenient to avoid carrying large amounts of cash or mandatory to effect an electronic means of payment e.g. internet purchases etc. ‘Know your client’ and anti money-laundering requirements can be satisfied by the account opening process.

This payments system can be complemented with a store of value card style card which is a Partner print card which has unique codes and is machine-readable by Partner terminals or possibly an ATM machine in order to effect and receive transfers to a card that doesn't require a bank account. This card is designed to cover any proportions of a given population who don't have mobile phones, either because they are not able to afford a mobile phone or prefer not to use a mobile phone. A traditional premium bond can be offered as an incentive to register for an account and utilise a minimum cash holding time for the customer where the required amount to create a premium bond prize out of the effective interest on the cash holding has been calculated.

This payment system has the possibility of providing a whole variety of savings products not normally available to the retail customer at any level (and certainly not at this non-banking level). These products could not only include normal savings products not normally accessible to non-bank clients but could also include esoteric products like the Hedgelet, mentioned above. This represents a huge convenience move for many potential customers who can't get banking but nonetheless want to access banks style purchase systems.

The current idea of an ex-territorial based central system and locally available cash accepting terminal network, that is interlinked to the mobile payments system is important, as the mobile payments system which operates essentially on mobile phones, can thus be tied to a money transfer product. Accordingly, somebody can not only make foreign exchange transfers to and from a mobile phone, but can also obtain a credit style debit card/rechargeable store of value card also tied the central system and make Forex transfers to it, and can thus have an alternative method of picking up money transfers from abroad. This store of value card adjunct is useful as there are, no doubt some people who travel to different jurisdictions and may want to have the ability for their parents and other relations to send money, without their having to interlink to the local mobile phone system as available (or not) in that particular country. The product thus also covers people who travel to countries where the mobile phone system may not be advanced enough in order for them to receive money transfers. The presence of different transmission bands for mobile phones in different countries and/or individual consumers lack of international roaming rights means that many mobile phone customers still have difficulties operating in other countries and that level of imperfection may restrain the process. Therefore the ability to transfer into any given territory in world is advantageous.

This method of payment of mobile phone/rechargeable store of value card will be very important with teenagers as well as people who cannot normally access bank accounts as many teenagers either do not have bank accounts or cannot access credit card systems to make internet payments, but nonetheless want to make huge amounts of purchases on the Internet—in particular music downloads which at the moment have download facilities tied to specific prepayment cards. This is obviously very inefficient, as all purchases have to be tied to a particular purveyor of goods and services, in particular music downloads (no doubt very enervating to teenagers who don't like to be limited in anything they do). A cash translating independent (non bank account linked) payment system that can affect Internet payments would be very attractive to an age group that is highly Internet centric in attitudes and purchase desires. Moreover many teenagers, who are also likely to have mobile phones, not only as a status item, but as an emergency item provided by parents for safety, are likely to prefer a system which is relatively easy for them to access such that all they have to do in order to make internet payments is to charge their phone with cash from a ticketing terminal in a shop (or get their parents to make cash payments or even credit card transfers via the net etc) and then to upload a unique central system generated code to the Internet which enables them to then download or purchase whatever they have chosen.

In jurisdictions that allow teenagers to buy premium bonds or lottery style products, the teenager's music download/internet purchase can have added to it, as an incentive to purchase, a product based on prepay cards/store of value cards that incorporates a lottery/premium bond element to the mobile phone payments product and target it for purchase by teenagers.

Product Group H—Using Attachment Method

Gaming And Near Gaming Products

Sports Betting Layoff Product.

This is a sports betting/football pools style of layoff product involving a skill element within a fixed odds betting system. It is offered on an online and a terminal network basis in a multiplicity of countries with a single currency valuation against which it is sold in local currencies.

Step 1

The gambling organisation stands in the middle allowing the customer to “back” or “lay” a gambling transaction to take a transactional charge in the middle which differs markedly from the ordinary bookie gambling methodology, where bookies quote odds that are very often worked out according to an odds compilers opinion. However, bookmakers do tweak their odds to include a percentage that in theory allows them to win money whatever the outcome. An example of this could be taken with a coin toss which has two potential outcomes: heads or tails. Mathematically the chance of a coin landing on either side is 50-50 so in a 100% book (whereby if the bookmakers take bets of the same stake on both selections they win nothing and lose nothing) the price for heads would be evens and the price for tails would be evens or 1/1. A bookmaker taking £110 on heads and £110 on tails would have “fielded” £220 on the event and would pay out £220 to the winning punters.

Betting to 100% is obviously not going to be profitable to a bookmaker as they neither win or lose money so they introduce a % deviation in their favour by offering less favourable odds on the same event. In this case they might offer heads at 10/11 and tails at 10/11. With the odds in their favour if they were to take the same bets again on both outcomes they would actually show a profit regardless of the result. So £110 on tails and £110 on heads once again fields £220 but this time the payout for either outcome would only be £210, which makes them a profit of £10 regardless. If the odds were tweaked even more in the bookmakers favour they could make even more profit. ½ heads and ½ tails with the same bets means again they would take £220 and this time only pay out ç165 on the winning selection, making them £55 profit either way.

With sports betting and horse racing it's slightly different as the outcome of matches and races can be influenced by external factors like the weather, the track, the time of year, injuries etc. In this case, a lot comes down to the opinion of the odds compilers and, having taken into consideration all these factors, their prediction of the outcome. Again, a percentage is introduced to the odds to theoretically guarantee a profit but with there being so many bookmakers, and therefore so many opinions, the odds can vary a lot from company to company. The key to being a successful bookmaker is knowing when a price is value to lay and also when it isn't but there is no formula for this as it comes from experience and in-depth knowledge of both the sport being priced up and figures/odds.

As a result, several modern online bookies are now looking to offer a different product which effectively arbitrages different market opinions about win/lose outcomes and allows the market to bet against itself whilst the gambling organisation stands in between gamblers in a brokerage role and makes its profit out of a transaction charge for matching win bets with lose bets. The attraction of this for the traditional gambler is that the transaction charge will be markedly lower than the bookies deviation which will have to cover potential losses when the predictions are not correctly matched by bets on both sides, i.e. when bettors don't match each other in a real time dynamic betting environment.

It is just such a product that is reproduced with special variations to make it acceptable in non-gaming jurisdictions. This is described below:

### EXAMPLE

Bets are taken by a gambling organisation on an international basis, which has already calculated the odds looking for short odds matches and offered them, grouped in one direction or the other on the results of international football matches that are likely to fulfill the short odds criteria. There will have to be a reasonable time gap between the announcement of the match and the match itself to allow for a near complete aggregation of intended transactions to match the secondary part of the process outlined below before the bets can be officially booked and paid for out of the deposited proceeds with the bookie. The purchaser is in effect putting a certain amount of money to win or to lose or draw. This product is therefore best effected by tie up with an Internet betting site based on a server or number of betting sites that offer win, lose or draw betting opportunities in a number of jurisdictions.

This betting pool becomes the amount of an international sports prize pool for “predicting” the results of a sporting match, especially football, as a skill game. It is in effect collected in countries where betting is allowed and people wish to place bets on win, lose or draw in a football match and/or other sports contests and matched in countries that are non-gambling on a skill prediction basis. It does not differ in any respect at this early point of collection of gambling countries bets from a traditional gambling product for example somebody places £1 for Chelsea FC to win which can generate a £10 win at 10:1 odds. This £1 for Chelsea FC to win is mirrored with a skill prediction for Chelsea FC to lose as the layoff product. The important point is nether “bet/skill prediction” becomes booked until the other is matched by the central system. The first bettor in the gambling permissive country is effectively looking for an arbitrager to find him someone to bet against. His interest in the product as opposed to a straight bet is that he becomes his own bookie. Something akin to this is being done by “Betfair” (which matches gamblers who are willing for example to put up £1 to win £10 on Chelsea FC to win—total winnings £11 stake £1—with gamblers who are willing to put up £10 to win £1 on Chelsea FC to lose—total winnings £11 stake £10), but crucially without the matching to non-gambling jurisdictions. What is thus new, is the matching procedure to non-betting countries where the odds are not immediately obvious to the “skill selector”. The proposed offerer or self bookie of the win transaction at 10:1 would have to pay a transaction cost of something like a minimum bet of £1.50 at 10:1 with only £1 counting for the odds calculation.

Step 2

The intermediary gambling organisation now contractually enters into a contract for £ X (which is the mirrored amount of the potential loss aggregated (i.e. lumping bets together) to buy time units of advertising time at a price equal to the aggregated potential loss on a mobile phone network from a company in a non-gambling jurisdiction.

Thus, just one side of the Betfair transaction is taken and aggregated it to place it in another country. What occurs is that the gambling company which has partly booked a bet in theory sponsors one unit of unspecified advertising time on a mobile phone equivalent to an up take of £ X of free mobile phone charges when this unit of advertising time which it has purchased can be used either for advertising messages from companies within the gaming company or sold on to any real advertiser. The counterparty in the non-gambling jurisdiction is offered £ X prize which is the aggregated amount of bets in one direction for predicting that Chelsea FC is going to lose and phones in to a phone number and has to listen to advertising before he is allowed to register his selection that Chelsea FC will lose. His prize is not booked until enough parties have phoned in to generate the mirrored amount for the whole transaction to be an arbitraging operation for two parties going in separate directions. This process is repeated for the win, lose or draw option on a number of matches. This advertising has been presold at a discount to generate part or all of the prize for the skills-based country where gambling is not allowed.

In reality the parties in both jurisdictions are being offered win, lose or draw odds as calculated by the bookie, but are being real-time matched, with the party in the non-gambling jurisdiction effecting a game of skill for a prize where the purpose is the purveying of advertising to the skilled predictor who is not entering into a gambling transaction against another predictor, but is spending money to listen to an advertising message in order to register his skill choice rather like any competition. In this respect, this transaction is Islamic and this is not considered to be gambling. Moreover, as the gambling organisation is only acting as a sponsored purchaser of an advertising unit of time, conceptually this advertising unit of time could be sold at a discount to real users rather than the registrar of a skill prediction. The entrant in the skill competition could therefore have his entrance fees in the form of mobile phone bills paid for by a real advertising transaction. The consumer pays for this as there would be an unacceptable degree of risk if the consumer was not in effect underwriting it. The operator stands as arbitrager in the middle and does not take gambling exposure, but does charge both sides transaction fees. The gambling side can be offered an extra option by rendering some of his minimum purchase monies into a lottery e.g. on a minimum bet of £2.00 which has a 75 pence transaction and lottery prize fees and of which £1 is the base purchase for the odds.

Apart from offering a fixed short odds based pre-match selection basis i.e. calculating a 10:1 chance of Chelsea FC to lose sophisticated gamblers can be allowed to nominate their odds e.g. 20:1 on Cameroon versus Trinidad & Tobago where there is no viewpoint again based on the minimum purchase idea. Again this is only booked once the non-gambling jurisdiction generates the corresponding odds related cash flow. The reason behind this extra option is although the likely odds can be predicted with a degree of skill for some well known teams, desire to spend mobile phone payments on rooting for a strange outcome with a relatively unknown and high odds team in non-gambling countries, can't be predicted. This form of market arbitrage allows the punter in the gambling jurisdiction not just to be their own better-than-market odds bookie but now to be their own high-odds bookie, in some cases where such odds might not be offered, with the operator acting as arbitrager of the market only booking matching transactions, i.e. tying the odds predictions of customers to what the market will bear.

One international number for the non-gambling countries is provided and the caller to this site will either charge it to his phone or phone a free phone number which can only be activated by a code purchased over the terminal network nominally paying for his phone call. Alternatively, the terminal network coding charge can be avoided where agreements, with local telecoms companies have been reached providing a portion of the international/mobile phone payment charge such that the cost of the advertised unit is not included in the real cost of the phone charge which goes to the phone company. This use of a terminal network is to avoid the charges becoming too large for prepay mobile phones by using a free phone number and then paying for the individual call with a code issued over the terminal network. The prize pool for the skill prediction in non-gambling countries win lose or draw is the aggregate of all previous bets and raises only as the layoffs raise.

A number of registration methods and odds arbitraging calculations can be utilised. A certain time limited period may be provided in which to ring in and register for a given prize size. The announcement of a prize can be delayed until a large series of bets has be aggregated so as to generate a higher prize size and then open the process for booking. The essential point is that a limiting system is provided to be able to match the bets generated in the betting country against the effective bets generated in the non-betting country.

This product is unsuitable to any other style of gambling transaction other than sports outcome prediction as the skill basis concept which is centred in the popular belief that that each person who is a knowledgeable football supporter for example can predict the outcome of a sporting match, as a matter of weighing the aggregate abilities of an individual team.

This system is obviously best tied to a mobile phone payment system, as it depends in the non-gambling country upon a person ringing in to one number for a win, one for a draw etc. The alternative of linking a prize draw terminal ticket purchased code selection keyed in on the phone numerical pad at the end of a designated waiting time is possible, but is likely to be more expensive. Alternatively, the terminal network can be used to generate a ticket that not only pays for the cost of the phone but generates a unique identifying number which will be tied to the predictions menu keyed in by the player. The erstwhile winner therefore validates his win by validating his ticket at a terminal in much the same way a lottery winner does. By use of a terminal network this product can be enabled to work with a landline/payphone system (for those potential customers who either don't own a landline or a mobile phone) by having a person buying a code over a particular terminal network system and then that person rings in to a particular line and so forth. In all cases a central system is needed as at some stage codes will be issued on tickets against cash payments for activation across a mobile phone and/or a landline system.

The central system approach is useful as a large number of potential winning predictions have to be accounted for and the system would enable use of a booking system such that a claimant goes with his mobile phone along with the unique text code which has been issued and sent as a text message from the central system to the phone at in order to claim his winnings. The use of a text link and other forms of mobile phone registration depend on the specific country's telecoms structures.

In addition to straight mobile phone/landline it is possible to have the ability to use a code issued across the terminal network, as a very different form of payment method to be used where telecom companies are either difficult to negotiate with or not technologically advanced enough.

Online Gambling Site Premium Bonds/Prize Schemes

This is a loyalty scheme aimed at online gamblers which dictates that as long as a certain amount is held in an online gambling account then that amount can enter a prize draw on a normal premium bond style multi-draw basis. There would have to be a minimum period in which this amount—here notionally $100 could not be pledged for a gambling transaction so as to allow it to build up an interest generated prize pool before the bond could be “put” (i.e. sold back) to immediately fund a gambling transaction that lost. A minimum amount that has to be held for a minimum period which is itself lower than the minimum amount required to enter the scheme could be required—the difference between the two being utilisable for a gambling transaction. By linking up with online gaming sites the terminal network can be used where jurisdictions permit to take payments to lodge in an online gaming account for people who wish to access internet gaming but don't have credit/debit card facilities that allow them to do this.

Having described particular preferred embodiments of the present invention, it is to be appreciated that the embodiments in question are exemplary only and that variations and modifications, such as will occur to those possessed of the appropriate knowledge and skills, may be made without departure from the spirit and scope of the invention as set forth in the appended claims.

What is claimed is:

1. A system for processing a multifunctional ticket, the ticket representing an entry item in both a short-term multiple-entry event and a long-term event, the system comprising:
Receiving means for receiving a request for a user entry into the short-term multiple-entry event;
Authorising means for implementing an authorisation event authorising the request, the authorising means being arranged to generate a unique ticket identifier associated with the user entry;
First storing means for storing the unique ticket identifier and a timestamp relating to the request authorisation event in a database record relating to a first function of the ticket;
Identification obtaining means for obtaining owner identifier information relating to an owner of the multifunction ticket independently of the authorisation event; and
Second storing means for storing the owner identifier information, the unique ticket identifier or an identifier uniquely associated with the ticket identifier and the timestamp or a date associated with the timestamp in a database record relating to a second function of the ticket,
Wherein the first and second functions are executed on different timescales and the first function relates to the short-term event and the second function relates to the long-term event.

2. A system according to claim 1, wherein the first function of the ticket is one of the functions selected from the group comprising (a lottery draw function, a gaming gambling function and a sports-result forecasting function).

3. A system according to claim 1, wherein the second function of the ticket is a long-term investment function and the long-term event is the maturity of the long-term investment bond.

4. A system according to claim 1, wherein the receiving means is arranged to receive a unique card registration identifier with the authorisation request and the authorisation means is arranged to access a pre-registered user database to determine whether the card registration number is valid for authorisation.

5. A system according to claim 4, wherein the identification obtaining means is a database of pre-registered users and the system further comprises means for querying the database to obtain details of the pre-registered user.

6. A system according to claim 4, wherein the identification obtaining means is a database of pre-registered users and the system further comprises means for querying the database to obtain a unique pre-registered reference identifier to the pre-registered user.

7. A system according to claim 6, wherein the second storing means is arranged to store the unique pre-registered reference identifier as the identifier uniquely associated with the ticket identifier.

8. A system according to claim 6, further comprising processing means for using an algorithm to convert the unique pre-registered reference identifier into the identifier uniquely associated with the ticket identifier.

9. A system according to claim 1, wherein the request is received from a remote ticketing terminal and the system further comprises transmission means for transmitting a unique identification number back to the remote ticketing terminal, the unique identification number being linked to the timestamp and the at least one user-selected option.

10. A system according to claim 1, further comprising a remote ticketing terminal for issuing the multifunction ticket.

11. A system according to claim 10, wherein the remote ticketing terminal comprises local authentication means arranged to carry out a local authentication procedure of the card owner.

12. A system according to claim 10, wherein the request includes at least one user-selected option and the first storing means is arranged to store the at least one user-selected option in the database record relating to the first function of the ticket.

13. A system according to claim 12, wherein the remote ticketing terminal is arranged to have access to the first storing means and is arranged on presentation of the unique ticket identifier, to determine whether the short-term event has occurred and whether the at least one-user-selected option associated with the unique ticket identifier, matches a stored short-term event result information item.

14. A system according to claim 9, wherein the receiving means is arranged to receive the unique identification number; and the system further comprises:
a remote ticketing terminal for issuing the multifunction ticket;
comparing means for comparing the received unique identification number with the unique ticket number stored in the first storing means; and
long-term event handling means for generating a unique long-term event identification number uniquely related to the unique ticket number and for sending the same to the second storing means if the unique identification number and the unique ticket number match.

15. A system according to claim 14, wherein the comparing means is arrange to compare the date of receipt of the unique identifier with the timestamp associated with the unique identifier and to enable generation of the unique long-term event identification number if the time between the current date and the timestamp is less than a predetermined value.

16. A system according to claim 9, further comprising:
a remote ticketing terminal for issuing the multifunction ticket; and
a remote issuing terminal for issuing a user-identifying entry in the long-term event, the issuing terminal comprising:
forwarding means for forwarding the unique identifier number to the receiving means;
entering means for enabling entering in of user identification information;
obtaining means for obtaining the identifier uniquely associated with the ticket identifier; and
producing means for producing a user-identifiable certificate for an entry in the long-term event.

17. A system according to claim 14, wherein the remote issuing terminal comprises a bank terminal for issuing a long-term investment bond from the providing means.

18. A system according to claim 14, wherein the remote issuing terminal is arranged to have access to the second storing means and is arranged on presentation of the identifier uniquely associated with the ticket identifier and user identification information, to determine whether the long-term event has occurred.

19. A system according to claim 14, wherein the remote ticketing terminal comprises a surrendering module arranged to enable surrender of a multifunction ticket for which the short-term event has passed and the long-term event has still to occur, the surrender module being arranged to enable the issue of a new multifunction ticket at a discount and to send instructions to the second storing means for the cancelling of the entry in the long-term event corresponding to the surrendered ticket.

20. A multifunction ticket or like information store for use with a system according to claim 1.

21. A multifunction ticket or like information store, representing an entry item in both a short-term multiple-entry event and a long-term event, the ticket comprising:
a machine-readable unique ticket identifier, the identifier providing means for identifying pre-registered information about the owner of the ticket; and
a timestamp or information relating thereto concerning the date of a ticket authorising procedure;
wherein a specific one of the multiple possible functions of the ticket can be determined and authenticated by use of the machine-readable unique ticket identifier and the timestamp.

22. A multifunction ticket according to claim 21, further comprising a plurality of prepaid elements, each element representing an entry into the multiple entry short-term event and into the long-term event, the ticket being arranged to mark each prepaid element once it has been used to participate in a multiple-entry short-term event.

23. A multifunction ticket according to claim 21, comprising an electronic data memory for storing electronic data, wherein the ticket identifier, timestamp and user-selected options are stored electronically in the data memory.

24. A multifunction ticket according to claim 23, wherein the ticket comprises a mobile telecommunications device.

25. A multifunction ticket according to claim 21, wherein the ticket identifier, timestamp and user-selected options are stored graphically on the ticket.

26. A multifunction ticket according to claim 25, further comprising an image of a collectable character or an element of a game apparatus.

27. A multifunction ticket according to claim 21, further comprising a series of user-selected options relating to the short-term multiple-entry event.

28. A combination of a system according to claim 1 and a multifunction ticket according to claim 21.

29. A method of processing a multifunctional ticket, the ticket representing an entry item in both a short-term multiple-entry event and a long-term event, the method comprising:
receiving a request for a user entry into the short-term multiple-entry event;
implementing an authorisation event authorising the request, the implementing step including generating a unique ticket identifier associated with the user entry;
storing the unique ticket identifier and a timestamp relating to the request authorisation event in a database record relating to a first function of the ticket;
obtaining owner identifier information relating to an owner of the multifunction ticket independently of the authorisation event; and
storing the owner identifier information, the unique ticket identifier or an identifier uniquely associated with the ticket identifier and the timestamp or a date associated with the timestamp, in a database record relating to a second function of the ticket,
the method further comprising executing the first and second functions on different timescales with the first function relating to the short-term event and the second function relating to the long-term event.

30. A method according to claim 29, wherein the request includes at least one user-selected option and the step of storing unique ticket identifier and a timestamp includes storing the at least one user-selected option in the database record relating to the first function of the ticket.

31. A method according to claim 29, wherein the first function of the ticket is one of the functions selected from the group comprising: a lottery draw function, a gaming gambling function and a sports-result forecasting function.

32. A method according to claim 29, wherein the second function of the ticket is a long-term investment function and the long-term event is the maturity of the long-term investment bond.

33. A multifunction lottery ticket, in which a unique entry into short-term lottery event is provided together with a means for registering into a long-term investment event, wherein a unique ticket number assigned to the lottery ticket for the short-term lottery event is related to a unique reference number provided on a carrier which can be provided for entry into the long-term investment event upon registration of the unique ticket number, the unique ticket number and the unique reference number being related to each other in a verifiable way which requires machine-stored information not present on the carrier.

34. A system for exempting the process of competing in a short-term gaming event from the strict Muslim definition of gambling, the system comprising means for using a portion of the user-paid price of entry into the short-term gaming event for investment in a long-term bond which is configured to repay the full cost of the short-term gaming event entry on maturity, the system being arranged to assign a unique short-term gaming event-entry identifier to an authorized short-term gaming event entry and to link the short-term gaming event-entry identifier with a long-term event identifier to a corresponding long-term investment bond.

35. A method of exempting the process of competing in a short-term gaming event from a strict Muslim definition of gambling, the method comprising:
purchasing a commercial good or service together with an entry into the short-term gaming event which is attached to the purchase of the commercial good or service;
using a portion of the user-paid price for the good or service for entry into the short-term gaming event;
authorising entry into the short-term gaming event at the same time as the purchase; and
providing to the user a receipt regarding the user entry into the short-term gaming event, wherein entry into the short-term gaming event is considered permissible under the strict Muslim definition of gambling, as it is attached as an incentive to a purchase the good or service.

36. A method according to claim 35 wherein the short-term gaming event is selected from the group comprising a lottery draw function, a gaming gambling function and a sports-result forecasting function.

37. A method according to claim 36, wherein the step of providing the good or service comprises providing a good or service selected from the group comprising: a money transfer service, a hedgelet, an insurance product, a real-estate product, and an advertising campaign.

38. A system for exempting a process of competing in a short-term gaming event from a strict Muslim definition of gambling, the system comprising:
a remote terminal for providing an ability to purchase a commercial good or service together with an entry into the short-term gaming event which is attached to the purchase of the commercial good or service;
a central server spaced apart from the remote terminal for using a portion of the user-paid price for the good or service for entry into the short-term gaming event; and
authorising means provided at the server for authorising entry into the short-term gaming event at the same time as the purchase;
wherein the terminal is arranged to provide to the user a receipt regarding the user entry into the short-term gaming event, wherein entry into the short-term gaming event is considered permissible under the strict Muslim definition of gambling, as it is attached as an incentive to a purchase the good or service.

39. A system according to claim 38, wherein the short-term gaming event is a lottery and the remote terminal comprises means for data entry of the purchaser's selected entries for participation in the lottery such that selection can be used by the authorisation means in the authorisation of the purchaser's entry into the lottery.

40. A combined lottery and low-value investment bond ticket purchasing system, the system comprising a plurality of remote terminals and a central server, wherein the central server is arranged to provide authorisation of each combined ticket and to adjust in real-time the value of the lottery prize in proportion to the number of tickets authorised.
